(19) United States
(12) Patent Application Publication
(10) Pub. No.: US 2015/0024351 A1
(43) Pub. Date: Jan. 22, 2015

(54) System and Method for the Relevance-Based Categorizing and Near-Time Learning of Words

(71) Applicant: Erik Landwehr, Saarbrucken (DE)

(72) Inventor: Erik Landwehr, Saarbrucken (DE)

(73) Assignee: Belingoo Media Group S.A., Remerschen (LU)

(21) Appl. No.: 13/825,802

(22) PCT Filed: Aug. 19, 2011
(86) PCT No.: PCT/EP2011/004198

§ 371 Date: Sep. 24, 2014

(30) Foreign Application Priority Data
Sep. 24, 2010 (DE) 102010046439.2

(51) Int. Cl. G09B 5/02; G09B 19/06

(52) U.S. Cl. CPC G09B 5/02; G09B 19/06
USPC 434/169

(57) ABSTRACT

A system and a method for timely learning of words and word units is provided, wherein annotations for the words and word units are offered and displayed in exact page synchronism with the source medium and the annotations can be selected by the user when reading the source medium. An author module provides a marking editor, which makes it possible to mark words and word units as annotations in synchronism with the display of the source medium and an annotation editor, which makes it possible to specify word basic data and meta data for the annotations. A database stores an annotation master data record for each annotation comprising word basic data and meta data. When reading a selected medium, a reading module displays a preset number of annotations in exact page synchronism with the display of the medium and allows the user-specific marking of an annotation, wherein the marked annotation is stored in a user-specific annotation data record of the database. This allows a reader, when reading and marking words to be learned, to instantly retrieve them for specific intensive training

Basically, the present invention is directed towards a system and method for the efficient set-up and timely learning of a differentiated vocabulary based on relevance-based categorizing of annotations.

In an increasingly globalized world, mastering several languages in addition to one's own mother tongue is becoming more and more valuable. Not only travelling around in foreign countries, but also operating and acting successfully in the business life increasingly requires knowledge of one or more foreign language/s in addition to the differentiated expression in one's native tongue.

Whereas previously, it was sufficient for this fluency to have a linguistic level described as “fluent”, it is today increasingly required to have a more refined vocabulary. This differentiated vocabulary is to allow not only reliable grasping and understanding of the issues negotiated especially in negotiation situations, but socially intelligent behavior in the negotiating team. For this, a differentiated vocabulary in each of the foreign languages is required, which clearly reaches far beyond a basic vocabulary. The present goal is to not only understand details using differentiated expressions, but also to be able to verbalize, in order to thereby influence negotiation situations and efficiently have influence on results.

Traditionally tools are available for learning such a differentiated vocabulary, such as dictionaries, which for a word in a foreign language specify several possible meanings in the mother tongue. It is therefore up to the learner to classify such a word as being appropriate, depending on the context. However, the learner is provided with no guidance which would allow him to be able to reliably assess or learn the contextual meaning of a word in a foreign language. Therefore, based on the currently available learning resources, the learner has no other choice than proceeding in a trial and error manner. This means the learner will apply a word in different situations and, based on the positive or negative feedback from the present native speakers, learn in which situations the use was appropriate and in which situations such use was inappropriate.

The necessary supportive attitude of the respective communication partner, however, is not to be assumed, in particular in the above mentioned negotiation situations.

Therefore, there is a need for learning materials that allow a learner, regardless of third party feedback, to establish a differentiated vocabulary in a foreign language for specific communication situations.

Furthermore, the learner is by prior art usually provided with a number of words to be learned, which are not customized to the individual requirements e.g. in the sense of individual interest, individual knowledge, etc. If the learner has acquired certain words for a current occasion, he can only learn them in the entirety along with a plurality of other words, which, however, may not be needed at all. If the learner then again learns this plurality of words, the specific context of meaning frequently has been lost for him, i.e. for the individual word that he has acquired for a current occasion, he then forgot which occasion this was precisely. Thereby an associative support is lost reducing the learning effect.

The invention is therefore based on an object to provide a system and an associated method for building vocabulary, in particular offering to learn in a timely fashion.

This object is satisfied by the subject matter of the independent claims.

Preferred embodiments are the subject matter of the dependent claims.

The invention enables a learner during consumption of a medium, for example, reading a text, listening to an audio file, watching a video, to in the respective language categorize individual words and/or phrases of the medium as being “relevant” for his individual learning, i.e. to evaluate them for determining relevancy and to specifically at any time retrieve the words thus categorized as being relevant, for example, the next day, for learning purposes. The learner can thereby without much effort define the individual and subjective relevant learning material almost en passent, i.e. synchronously to perceiving the medium, and repeat exactly this individual and subjectively relevant learning material—and only this—, supported by filter-based selection of subjectively relevant terms and expressions for efficient intensive study. In particular, he can do so in a timely manner and is not burdened with other especially not individually relevant vocabulary. The learner is in a timely manner enabled focused and thereby efficient repetition of the relevant learning material, e.g. by retrieving words that were categorized as being relevant on the pages of a book that he just read. Therefore, learning is in that moment still associated with the context just read and intensive learning is facilitated. The learner is therefore enabled to thus repeat the relevant learning material in a timely manner with respect to the perception of the medium, such that it is still present, which words or phrases were categorized as important for what reason, what the context they were in etc. Furthermore, the learner is in turn enabled to also in a timely manner prepare himself for reading a medium in a foreign language, in that the learner specifically selects the relevant words of the next reading section in preparation e.g. by means of a filter and lean them in advance. These possibilities of timely learning therefore clearly increase learning results.

According to a first aspect of the present invention, a computer-implemented system is provided for relevance-based and timely learning of words and word units, wherein annotations for the words and word units are offered and displayed in exact page synchronism with the source medium and the annotations can at a specific time be categorized and selected by the user with reference to their relevance.

In this, “in exact page synchronism” indicates the possibility of associating an annotated word to a certain “page” of the medium, so that the learner can in sync to reading this “page” categorize the individual and subjectively interesting words as being “relevant”. Thereby, the learner can limit the categorization to the most interesting words and simultaneously categorize them in a timely manner, i.e. specifically retrieve relevant words and learn them by repetition. In each of these repetitive learning processes, the categorization can be changed or adapted by the learner based on changing learning success and/or changing focus of interest.

In this, a “page” can have the traditional meaning of a page of a book, but can also specify a different display unit, such as a page in a Web browser, a time period in an audio file and/or a defined section of a video. Achieving allocation in exact page synchronism can include the use of a conversion table or a matching table, respectively, for example, when different editions of a particular book are used and these editions have different page breaks. If, for example, annotations were made to a copy of the Gutenberg Bible and the Gutenberg Bible therefore serves as a reference medium, but the reader is reading a more modern edition of the Bible and there performs categorization of the relevance of individual interesting and thus relevant words, then the table serves page conversion form one edition to the other.

This system according to this aspect of the present invention comprises an author module which comprises software-implemented means being adapted to load a source medium in a converted manner, further being adapted to provide a marking editor which in synchronism to the display of the converted source medium enables marking of words and word units as annotations and allocating a linguistic level and parameters of the knowledge category to the annotations and further being adapted to provide an annotation editor which parallel to the display of the converted source medium enables specifying word basic data and meta data to the annotations.

Furthermore, the system according to this aspect of the present invention comprises one or more databases, which based on the entries in the marking and annotation editor for each annotation store an annotation master data record consisting of the word basic data and meta data. These databases further for each annotation based on the meta data determine and store a relevance and additionally for each source medium store at least one matching table defining the allocation in exact page synchronism for each annotation with respect to a medium and relative to a reference medium.

Furthermore, the system according to this aspect of the present invention comprises a reading module having software-implemented means being adapted to select one or more media, being further adapted for each selected medium to store a multidimensional relevance prioritization for annotations to be displayed based on the categories of the meta data, further being adapted while reading one of the selected media to display a predetermined number of the relevance-prioritized annotations parallel to the medium in exact page synchronism to the medium, and further being adapted to provide functions for updating user-specific relevance of an annotation based on user-specific parameters for one or more elements of the meta data, where the annotation is stored with the updated relevance in a user-specific annotation master data record of the database.

By means of the learning system according to the invention, a solution is therefore provided which realizes improved possibilities of context-oriented language training. The solution is based on the realization, that for efficient language training, words should be learned in their context and this across different media, such as books which should be available in various digital formats, e.g. ePub, PDF, etc. or even analog as well, such as audio or video. Furthermore, the invention is based on the realization that a number of categorized words determined by the learner according to their relevance should be displayed ideally in exact page synchronism and in parallel to the display of such an analog or digital medium. By means of the (new) categorization of displayed words available in synchronism to reading the medium, timely repetitive learning by means of retrieving the filtered vocabulary lists can thereby be offered page-exact (words of the last pages read, or the pages to be read next) or word-exact.

Furthermore, the present invention is based on the realization that context-sensitive language training by means of these various media then gains efficiency, if annotated words or annotated word units, respectively, are offered in a page-exact manner in synchronism to the flow of reading across these various media or across the different formats and/or even editions of these media, so that regardless of the medium, e.g. whether a text, an audio file or a video file is given, whether the text is physically read, a book and/or text, audio, or video files are offered across various digital platforms and formats, the user can respectively by means of filter adjust the annotation or the words to his individual needs.

With this prioritization of needs, the present invention utilizes the realization that the users prioritization of learning is determined mainly by the factor of relevance, which is determined in an embodiment of the invention at least by importance and level of knowledge from the perspective of the learner.

Therefore, the object is satisfied in a further aspect of the present invention by a computer-implemented method for relevance-based learning of words and word units, where annotations to the words and word units are offered and displayed in exact page synchronism with the source medium and the annotations can at any specific time be categorized and selected by the user with reference to their relevance.

The method according to this aspect of the present invention comprises loading, converting and displaying a source medium and to marking the words and word units as annotations in synchronism with the display of the converted source medium and allocating parameters of the linguistic level and the knowledge category to the annotations.

Furthermore, the method according to this aspect of the present invention comprises specifying word basic data and meta data to the annotations in parallel to the display of the converted source medium, storing an annotation master data record based on the specified word basic data and meta data for each annotation consisting of the word basic data and meta data, and determining and storing a relevance value for each annotation based on the meta data of the annotation, and creating and storing at least one matching table for each source medium which defines the allocation in exact page synchronism for each annotation with respect to a medium and relative to a reference medium.

In addition, the method of this aspect of the present invention comprises selecting one or more media and storing a multi-dimensional relevance prioritization for annotations to be displayed for each selected medium based on the categories of the meta data as well as selecting and displaying a preset number of relevance-prioritized annotations while reading one of the selected media in exact page synchronism in parallel to the display of the medium.

Finally, the method of this aspect of the present invention comprises updating the user-specific relevance of an annotation based on user-specific parameters for one or more elements of the meta data, where the annotation is stored with the up-dated relevance in a user-specific annotation data record.

In a further aspect of the present invention, a computer-readable storage medium is provided in which computer-readable instructions are stored, which when executed by a computer are adapted to perform the method steps explained above.

Therefore, the present invention offers the advantage that the user can respectively in each session newly access personalized vocabulary by possibly modified values of importance and level of knowledge and select or prioritize, respectively, only those words that correspond to his filter setting in the specific session (e.g. regarding importance and level of knowledge) on the one hand, and the current relevance of personally associated words (likewise, for example, on the basis of importance and level of knowledge) on the other hand.

In this manner, the advantage of relevance orientation is realized enabling efficiently establishing an even multilingual differentiated vocabulary on the basis of annotated expressions and word units. Furthermore, the present invention offers the advantage that the user receives annotations for the text in exact page synchronism to reading the original source, i.e. displayed in the flow of reading or of pages of an original text, and is respectively simultaneously offered the possibility of categorizing the annotated expressions and word units.

Conceptually, the system according to the invention is based on multilingualism in all language pairs (source languages/annotation language) and character sets. In the field of audio, several pronunciations can be offered. This allows in an advantageous manner to observe language dialects or different pronunciations, for example, the distinction between Australian, Irish, Texan or British pronunciation of English words.

Other preferred embodiments are specified in the dependent claims and are described below with reference to the accompanying figures, where:

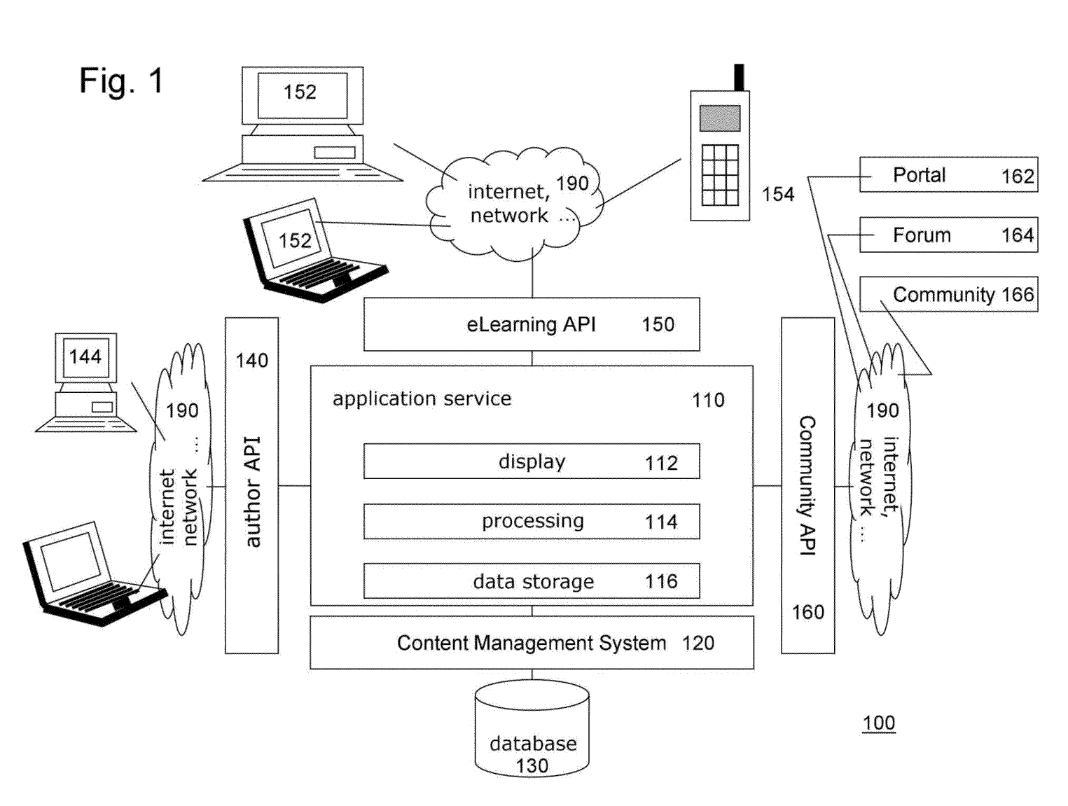

FIG. 1 shows a schematic architecture and structure of an embodiment of the system according to the invention,

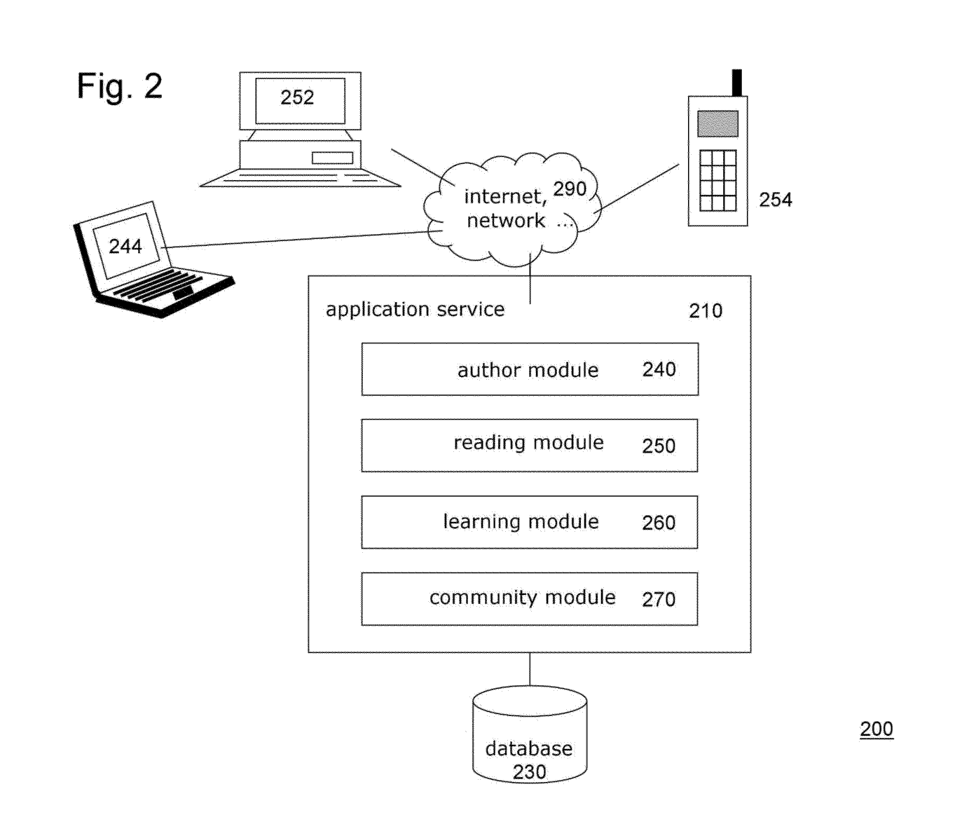

FIG. 2 provides a schematic overview over the module structure and set-up of an embodiment of the present invention,

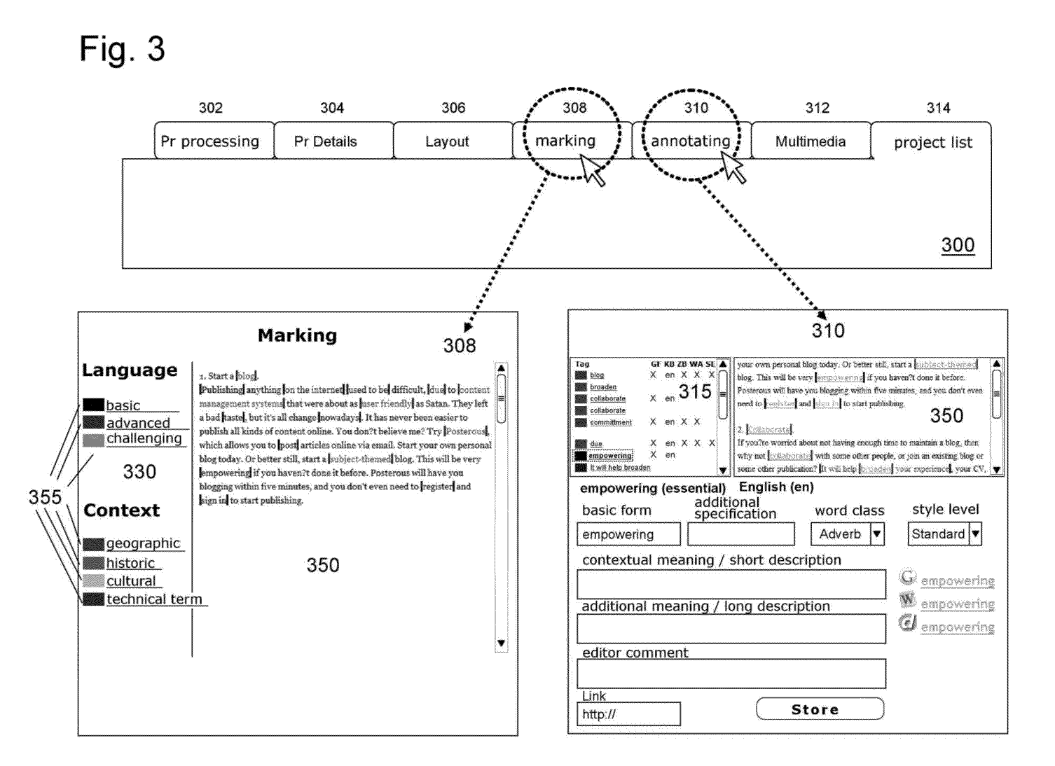

FIG. 3 shows a schematic representation of graphical operating elements of an application window of the author module according to an embodiment of the present invention,

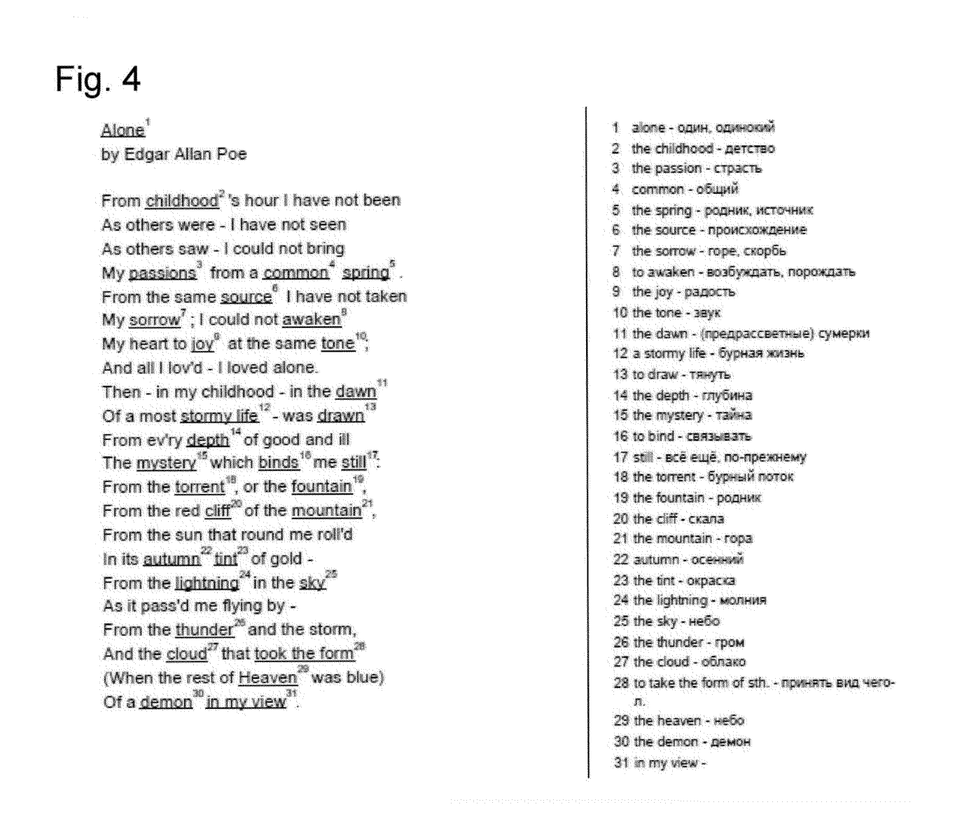

FIG. 4 by way of example shows the structure of a reference medium according to an embodiment of the present invention,

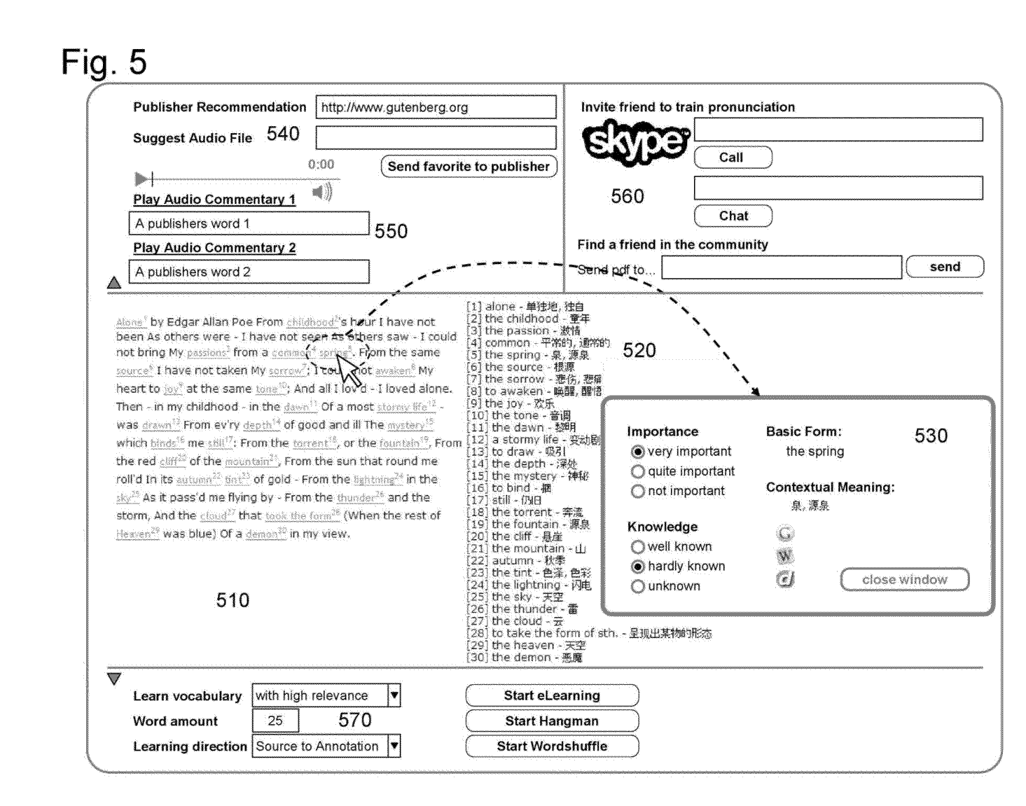

FIG. 5 shows a schematic representation of graphical operating elements of an application window of the reading module according to an embodiment of the present invention,

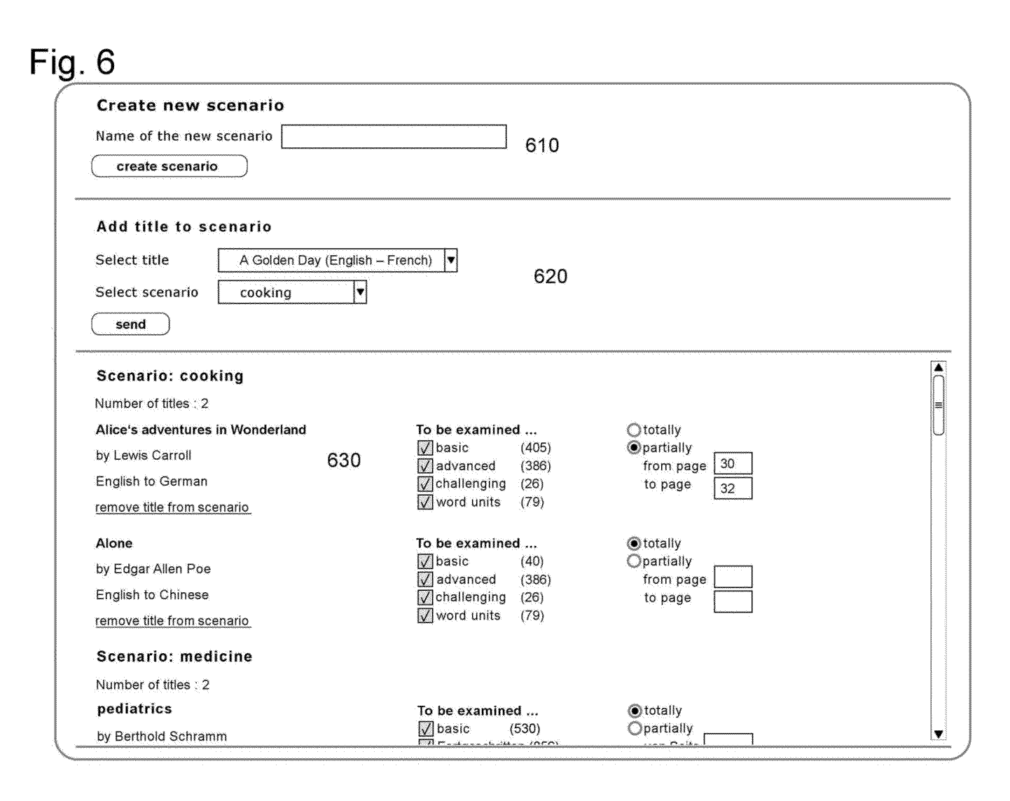

FIG. 6 shows a schematic representation of graphical operating elements of an application window for scenario creation according to a preferred embodiment of the present invention, and

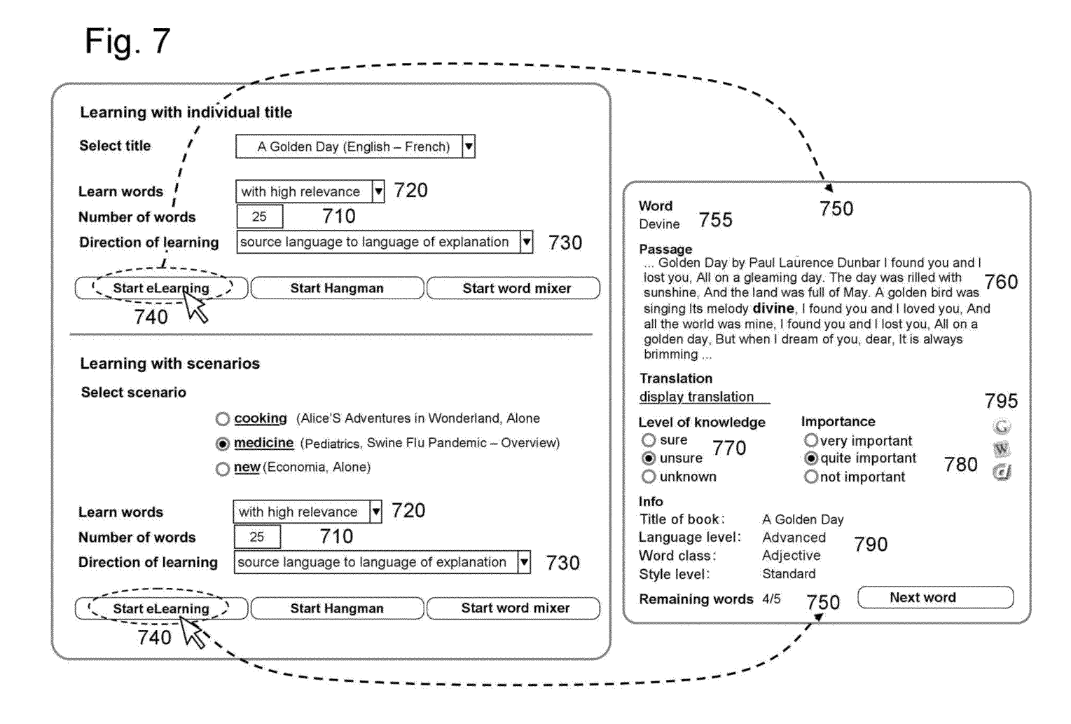

FIG. 7 provides a schematic representation of graphical operating elements of an application window of the reading module according to an embodiment of the present invention.

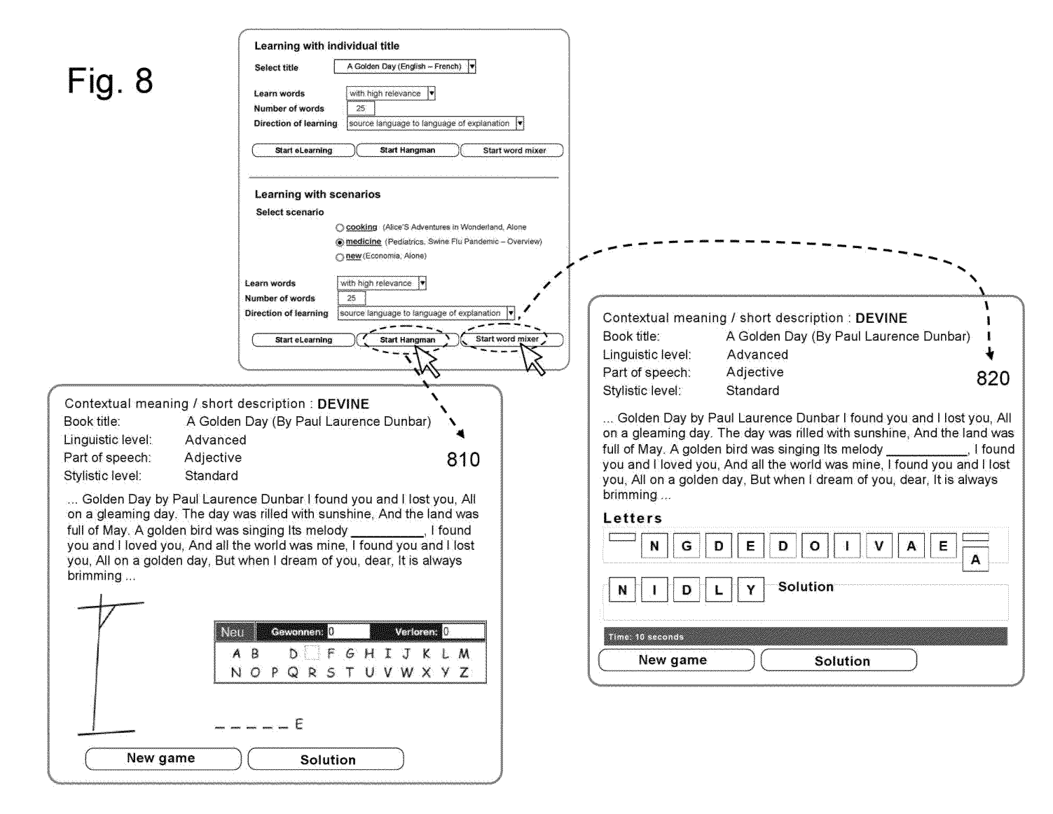

FIG. 8 shows a schematic representation of graphical operating elements of examples of educational game modules according to an embodiment of the present invention.

FIG. 1 shows a schematic architecture and structure of a relevance-based system according to the invention for efficiently establishing a multilingual differentiated vocabulary by reading and categorizing annotated expressions and word units in synchronism.

The relevance-based teaching system 100 according to the invention comprises an application service 110, a content management system 120 or a browser, respectively, which is connected to databases 130, and the application programming interfaces (API) for authors 140, learners 150, and community participants 160. The eLearning API 150 is in a preferred embodiment connected to terminals 152 and 154 via a data network 190, preferably the Internet or mobile radio networks. Terminals 152 are preferably a computer 152, a portable computer 152 or a similar portable computer terminal or laptop 152. The terminal 154 is preferably a mobile telephone terminal 154, for example a Smartphone 154 or a multimedia device 154. The type and number of terminals 154/152, however, is more by way of example, so that in embodiments of the present invention, a different, specifically larger number of terminals 152/154 [sic]. Furthermore, other or similar or even alternative terminals 152/154 can be used in embodiments of the present invention.

The eLearning API 150 according to the invention is preferably adapted such that it enables the greatest possible versatility of use of the application service 110 in different fields of application on terminals 152/154. In particular, in a preferred embodiment, the eLearning-API 150 is adapted such that it complies with the needs of an Internet-based e-Learning application. Therefore, the eLearning API 150 provides all functionalities necessary for performing a user-controlled learning concept. The definition of this interface 150 comprises all available methods, the number and data types of the functionality parameters, and the data type of the return values in the application service 110. The definition of the APIs 140-160 are retrievable as stand-alone third-level domains.

Preferably, broad applicability of the eLearning API 150 is ensured by the use of standards in the implementation, in a preferred embodiment by the use of Web Services Description Language. Preferably, the community application programming interface 160 and the author API 140 are designed in a similar form. The APIs 150, 160, 190 are preferably adapted such that other application environments can access the functionalities and the application service 110 via these APIs. For example, in a preferred embodiment, the eLearning API 150 is adapted such that an application being installed on the mobile terminal 154 can use this interface to connect to the application service 110 and thereby use the eLearning API 150 as the data provider. More preferably, the community API 160 is adapted such that, for example, various Internet-based portals 162, forum environments 166 as well as community environments 164 can access the functionality and the application service 110. An example of such an environment 162-166 is the ever more popular Facebook community. Similarly, however, in a preferred embodiment of the system 100 according to the invention, also third-party environments, such as search engines (e.g. Google, Bing, . . . ), forums, or even book stores (e.g. Amazon . . . ) access the functionalities of the application services 110 via the community API 160. For this, the third-party platforms 162-166 are preferably connected to the community API 160 via a data interface 190. In a preferred embodiment, this interface is formed by the Internet and/or a mobile network environment.

In a similar manner as the above explained third-party environments 162-166 access the community-API 160 or as the terminals 152/154 access the e-learning API 150, respectively, also the terminals 144 access the author API 140. The author terminals 144 are preferably designed as computer terminals 144 interacting in the embodiment of a PC, a mobile computer terminal, a laptop computer or even a Smartphone, via the author API 140 with the application service 110. Similarly as described above, the terminals 144 via a data interface 190 access the authors API 140 then providing the functionality and the application services 110 on the terminal 144. In a preferred embodiment, this interface 190 is formed by the Internet or a mobile network, such as a mobile phone network. Furthermore, in a preferred embodiment, the application service 110 is executed on one or more server computers which are accessible by the terminals 144, 152, and 154 as well as by the third-party platforms 162-164, for example, via WAN networks such as the Internet. In principle, however, any form of connection having a corresponding data protocol is suitable to enable the application service 110, i.e. the server computer's on which the application service is provided, to connect to the terminals or the third-party platforms, respectively.

In a further preferred embodiment, the application service 110 is connected via a data interface to a content management system 120 being installed on the same or on other server computers. Thereby, the application service 110 can in a preferred embodiment be implemented as a system extension expanding the core functionalities of such a content management system 120, for example Typo3. In another embodiment, the functionalities of a content management system 120 can be implemented as separate or integrated distributed functionalities independent of a content management platform, e.g. also be incorporated into the functionalities of the database 130.

Preferably, the application service 110 enables answering remote procedure calls, which are transmitted via the networks 190 or the APIs 140-160, respectively. In a preferred embodiment, the application service is implemented in according to a service-oriented architecture and uses rich standard description languages, such as XML, as a message format using a common messaging protocol, e.g. HTML. The preferred embodiment according to a service-oriented architecture and the use of rich standard description languages like XML enables increased usability in a variety of application platforms and easy accessibility of a large number of different terminals. Thereby, the application service 110 is preferably accessible and usable from a broad base of different clients using most different techniques.

The implementation of the application Service 110 according to the invention is in a preferred embodiment based on modeling the system classes according to the Model View Controller software architecture paradigm. Therefore, the application service 110 in a preferred embodiment has three separate application layers that realize representation of data 112, processing of data 114 and data storage 116 even each with separate functionalities and responsibilities in different parts of the program. Therefore, maintenance, extension and re-use are ensured. The application layer data storage 116 and processing 114 are preferably used for generating new views 112 within the content management system 120, based on the generation of XLM messages. In a further preferred embodiment, the data model is swapped out into a separate class hierarchy, thereby creating the basis for redundancy-free data backup in its own integrity. The database 130 is respectively accessed only at one point and at defined times, so that the exchange of information between application layers 112-116 via the content management system 120 to the database 130 can at all times be monitored and optimized. Therefore, the application service 110 is in a preferred embodiment directly and/or via the content management system 120 connected to the database 130 in which the required primary data e.g. texts and vocabulary, annotations etc. is stored.

The number and configuration of the database(s) 130 or their connection to the content management system 120 and/or the application service 110, however, are of exemplary nature only. In particular, the database 130 can be implemented by one or multiple databases, be run on the same or other server computers 120 than the content management system 120 and/or on the same or other server computers than the application service or the APIs 140-160, respectively. Therefore, in different embodiments of the learning system 100 according to the invention, not only one but several databases 130 can be connected in different ways to the content management system 120 and the application service 110. Furthermore, the connections from the application service 110 can as shown exist via the content management system 120 or the database 130 and/or there can be a parallel or alternative direct connection between the application service 110 and the databases 130.

The application service 110 therefore preferably realizes a variety of functionalities that are provided via the APIs 140-160 in different application contexts and on different terminals 144-154 and third-party platforms 162-166. Preferably, the application service 110 inter alia realizes functionalities that test accessibility of the application service 110 and thereby serve client developers in the correct implementation of a client 162-166. Such functions preferably hand over a value and in this manner ensure communication between the client to be developed and the server which contains or runs the service application 110, respectively. The application service 110 preferably realizes a login functionality, which logs a user of a third-party environment 162-166, a terminal 152/154 or a terminal 144 as a front end user onto the application service 110 and/or the content management system 120. Preferably, the user name and password are passed on and recorded with the registration. A hash string is returned which serves as user identification for the following API requests and by means of which the user session can be restored. Furthermore, a log out functionality is preferably provided by the application service 110 that that logs out the previously logged-in front end user from the application service 110 and/or the content management system 120. This feature ensures that user-specific session data is deleted from the database 130.

In a preferred embodiment, the application service 110 further provides a functionality that returns e-learning-relevant data of all media purchases of the front end user. This functionality “Get books” uses the parameters of the session-ID and returns the data type “Book”. In a preferred embodiment, the application service 110, in addition to this one, provides a further functionality that not only returns data of all media purchases, but also the eLearning-relevant data of all scenarios of the user. In a scenario, multiple titles, e.g. books are in a preferred embodiment grouped together to form a study unit. These books can e.g. originate from different areas of knowledge and thereby enable learning words in different contexts of meaning. Preferably, it can be indicated for each title within the scenario, which words are to be queried thereform. In a scenario data record, multiple text sources, e.g. books, are therefore contained as data records of the “Book”-type, namely precisely those which were compiled by the front-end user within a scenario. Together with the previously described functionality “Get books”, which, like the “Get scenarios” uses the session ID as a parameter, the return values of these two functionalities serve as a basic data record for the media selection by the learner.

On the basis of these functionalities, the actual data of words is preferably made available in a user-specific manner in a further functionality “Get learning tags by book”, by means of which the front-end user will learn in the next step. This functionality in addition to the session ID uses the parameters Order ID, Distribution Type and Word Count as parameters.

The parameter Order ID identifies the specific medium, the content of which the front-end user or the learner, respectively, wants to select as the basis for the respective session.

The parameter of the Order ID is specified in the database by means of previous purchase transactions of the user. Therefore, shop functionalities are in a preferred embodiment offered via the application service 110 and/or in another preferred embodiment via the foreign platforms 162-166. By means of these shop functionalities, the end user can in this preferred embodiment purchase annotated texts, or media or multimedia files, respectively, so that the end user can access them in that he accesses the eLearning API 150 from a terminal 152/154.

In another embodiment, the eLearning API 150 can alternatively be adapted such that access to the media is effected via a read-API 155 and a learn-API 153. Instead of an integrated interface for both functions, eLearning API 150, two separate APIs are In this embodiment implemented, firstly for the read functionalities (read-API 155) and secondly for the learn functionalities of the system 100 according to the invention. The technical framework and implementation forms explained above for the eLearning-API 150 in this embodiment apply in the same manner to the read-API 155 and the learn-API 153.

Preferably, these annotated media are stored as electronic texts and/or media files in the database 130. By means of the meta data being appended to each of these media, the end user can decide which medium corresponds to his particular study interest. Preferably this meta data includes at least information about the publisher, the content medium, such as text, audio and/or video, the source language, the language for explanations and the number and types of annotations, inter alia the number of words explained, the number of words in different degrees of difficulty and the number of words explained in different word categories. This meta data allows the end user to purchase a desired title in a personalized manner, e.g. on the basis of one's own language, the respective linguistic level, the annotations displayed according to categories or level of difficulty of the annotated words, the font size, the layout, and other filters, such as word units, subject terms, and the like. In addition, the purchase can preferably differentiate between black and white or colored media. The personal word base of the respective end-user being stored in the database 130 is in a preferred embodiment considered during the purchase of a personalized title. It is preferably extracted from this personalized word base, which words or word classes from the perspective of the individual user were assessed as being firstly “important” and secondly “known”. On this basis, a personalized version of the medium can be created preferably in an automated manner in which only those words are highlighted as annotation, which were identified at least as being “important” or “unknown”, or both, based on the existing word base of the user in the database system 130 of the of the system 100. Such personalized purchased titles or such a personalized medium is given a unique Order ID.

Based on the parameter Order ID specifying such a personalized medium, the parameter Distribution Type determines the selection of the relevance as desired by the learner of the words to be learned on the basis of the personalized medium. In a preferred embodiment, this parameter has an initial value selecting only those words with a “high” relevance However, this parameter can be amended by user input such that also those words having only a “low” relevance are selected or only those having a “very high” relevance.

The parameter Word Count furthermore limits the number of words to be learned on the basis of the personalized medium identified by the parameter Order ID. This parameter also has a default value in a preferred embodiment, which, for example, is set to 25. However, this value can also be amended at any time by user input.

The functionality “Get learning tag by book” therefore provides a functionality algorithm, which based on an identified personalized medium selects the words that are of significance for the current study session. The functionality algorithm in addition to the three parameters mentioned will in a preferred embodiment further consider information that is queried by the end-user.

Preferably, this additional information is such as those regarding the level of knowledge of the learner with respect to specific words, such as those regarding the significance of specific words and furthermore the functionality algorithm in a preferred embodiment observes the last learning time and the occurrence of specific words in the text.

In analogy to the functionalities “Get books” and “Get scenarios”, the application service 110 further preferably has a functionality operating in analogy to the “Get learning tags by books”, but involves as a data basis all the personalized media contained in a scenario. Preferably, the distribution of words in the result set is determined inter alia on the basis of the proportion of the number of words per book to the total amount of words in the scenario. That means that preferably media containing only a few words also have a share in the result set only with a correspondingly lower proportion. Return values of the two functionalities is a basic data record each for the word selection by the user on the basis of the highlighting in the text, i.e. annotations or tags, which are identified in the media.

The feedback of the learner during the session is in a preferred embodiment during the session recorded by the “Get learning feedback” as feedback from the learner. For each annotated and displayed word, the user can set one or more parameter values, in a preferred embodiment, those that reflect the user's level of knowledge with respect to this word (knowledge) and those that reflect the users assessment regarding the importance of each word (importance). Each word, preferably identified by an ID tag therefore in one embodiment receives a personalized relevance being calculated at least using the combination of the values of “knowledge” and “importance”. This personalized relevance in relation to a single word is associated with the Order ID of a personalized medium and stored in the database 130 of the learning system 100 for each user, so that this personalized relevance can at any later time be used for this user in the calculation of the words relevant for learning. This means, the selection algorithm of the functionality “Get learning tags” described above (based either on a book or based on a scenario) respectively in each session newly uses the personalized vocabulary possibly modified by values of importance and level of knowledge and in the functionality algorithm accordingly selects only those words that correspond to the filter setting of the user in the specific session (e.g. regarding importance and level of knowledge) on the one hand, and the current relevance of personally associated words (likewise, for example, on the basis of importance and level of knowledge) on the other hand.

In this manner, a relevance-based system 100 is realized enabling efficiently establishing a multilingual differentiated vocabulary on the basis of annotated expressions and word units. The functionalities of the application service 110, which were explained above, by way of example show the basic functionalities of the application service 110. In embodiments of the present invention, therefore, the number and/or implementation of these functionalities can vary, in particular, additional or more functionalities and/or other or also different or alternative functionalities can be implemented. These different functionalities or variants, respectively, of the above-explained basic functionalities of the application service 110 allow realization of a variety of applications in which the learning system 100 is implemented.

In a preferred embodiment, all these applications have in common the synchronous reading of an original source, i.e. the original text is read in synchronism with the annotation to this text and in an embodiment of the invention the possibility of categorizing the annotated expressions and word units is simultaneously offered to the reader.

In one application scenario, the original book or the print-out of a digital medium downloaded via the terminals 152/154 serves as the reading medium. Synchronous with reading page by page in the actual original book or the print-out on the one hand, the explanations or annotations, respectively, are in this case of application retrieved in parallel on a computer terminal 152/154. This means, even if the reader has a non-annotated original book as a reading source, annotations to this source, i.e. of a selected relevant set of annotated words for this medium, can be provided by a digital terminal 152/154 so that the user can in page synchronism during the reading read and categorize annotated vocabulary. This means, the user will via the digital terminal, e.g. ideally being a so-called smart phone 154, see annotated words selected by means of the “Get learning tags”, apply a subjective assessment at least regarding the items importance and level of knowledge to them in accordance with the “Set learning feedback” functionality and store the thus updated word data record in the data-base 130 of the learning system 100, so that it can optionally be retrieved in a different reading session.

Another case of application is one in which both text and annotation is read via a digital terminal 152/154. In one case of application, the Internet browser preferably uses a personalized title or a personalized medium, respectively, and the annotated words in the text being read are marked by graphical highlighting. In a preferred embodiment, this annotation is displayed either by mouse-over (the cursor moves over the highlighted word) or by clicking on the highlighted word. In this case application, the annotated term is preferably displayed together with explanations and its current categorization e.g. with respect to importance and level of knowledge in relation to the respective user. This display of the explanation and categorization, preferably being displayed as a window superimposed on the text, in this preferred embodiment further comprises functionalities that allow the user to directly update the annotated term with respect to its categorization i.e. a giving a further or new subjective assessment regarding e.g. importance and the level of knowledge with respect to this term.

In a similar manner, the learning system 100 according to the invention enables reading titles or media, respectively, in a variety of other formats, such as the ePub format (an open standard for e-books from the International Digital Publishing Forum replacing the older Open eBook standard), an alternative eBook format, as an interactive PDF, as a website in the browser, or the like. Furthermore, the learning system 100 according to the invention enables the electronic formats of the media or titles, respectively, to be read on different platforms or terminals 152/154, respectively, or third-party platforms like 162 to 166 or even a multimedia terminal such as a television set. Irrespective of the respective medium or format and also irrespective of the respectively used terminal 144-154, the annotations can each not only be read in page synchronism but the annotated words can also synchronously be applied an updated user-specific categorization. In this manner, a user-customized vocabulary arises during reading in the learning system 100 according to the invention, for example, which can while reading be updated and categorized by the user regarding importance and level of knowledge or regarding further or additional or even alternative categories. This catalog of currently categorized terms can be used by the user for future vocabulary training. In order to make the vocabulary training as efficient as possible, the words can in a preferred embodiment be filtered according to various criteria, such as based on the categories of relevance e.g. importance and level of knowledge, but also in relation to the title from which these words are to originate, the subject area, the occurrence in the text, or contextual restrictions, such as terms from geography, from history, from the field of culture and/or technical or even legal or managerial terms.

The learning system 100 according to the invention further enables localization of text units in a medium that are to be read in a reading session e.g. by means of the page number. In this manner, the user can at the beginning of a reading session enter from which page to which page in the medium he intends to read during this session. This information can in a preferred embodiment be used to optionally after or before reading this particular text display in the respective personalized medium in advance as a summary all terms categorized with a specific measure of relevance, i.e. after reading the specific text unit or in preparation, i.e. before reading this text passage. In a preferred embodiment, this preparatory or summarizing display of a large mount of words can also be dynamic such that such a preparatory or follow-up compilation of words is displayed in the medium, for example, after a certain measure, such as after every five pages or before the next ten pages of text. The display of such lists of words can here be based on both the subjective categorized relevance on the basis of e.g. importance and level of knowledge as well as on the basis of an objectively determined relevance, which e.g. could be determined on the basis of textbooks and/or dictionaries. Furthermore, such relevance values can be predefined by community input, which is determined for a certain medium such as by the third-party platforms 162 to 166.

Therefore, the learning system 100 according to the invention in a preferred embodiment also provides categorizing words in texts which have not yet been annotated by a bilingual author. In this case of application of the learning system 100, the user or in an a web browser will read the text of a foreign language news portal online, for example, transfer this medium into the media database 130 of the learning system 100 by means of a link or in parallel to reading the news text mark a term in the news text by means of an add-on application of the learning system 100 integrated into the browser, and thereby include that term in the vocabulary database 130 of the learning system 100, and simultaneously deliver a personal categorization for this term, which is stored with the translation of this term in the vocabulary database 130.

The initial translation of the term from a non-annotated text is in an embodiment done, for example, by means of reference books such as electronic dictionaries, online dictionaries 162-166 etc. Within this meaning, online dictionaries are other third-party platforms 162 to 166, which can be connected not only via the community-API 160, but also via the author-API 140 to the application service 110. While in this case the identity of the source is provided via, for example, the Internet address (URL) of the news text body, the case of application similar to this case of application of a physical source can be implemented, such as in a non-annotated book, by the learning system 100 according to the invention such that the title of the book is either entered directly or identified by the bar code of the book. This bar code number or a source number such as the ISBN number of a book is transferred by the user to the learning system 100 and in this manner, the application service 110 can in communication with the third-party platforms 162 to 166 indentify the underlying source or the title, respectively.

In a preferred embodiment, the application service 110 therefore has a further functionality which allows a user to take an image of the bar code of a book, for example, using the camera of a Smartphone, and send this image via the Internet to the application service 110. The corresponding functionality interprets this image by means of image evaluation algorithms such that the semantic meaning of the respective bar code is read out and the book can be identified in the databases of third-party platforms 162 to 166.

Therefore, the relevance-based learning system 100 according to the invention for the set-up of a multilingual differentiated vocabulary provides functionalities that allow the user to use any text for reading from e.g. Websites, digital media, in browsers or other platforms, such as an eBook reader either digitally or even physically, to use annotations in page synchronism for these texts and/or highlight unknown words in this text as annotations in order to then provide the respective terms with a personal customized relevance categorization corresponding to that point in time, which is characterized at least by parameters such as importance and level of knowledge. In a similar manner, the learning system 100 according to the invention not only enables processing text media but also to use of audio and video sources as a starting point for the learning process. For this, for example, subtitles are used for video media as the annotation medium and in the context of audio media, speech-to-text software is used for translations.

By means of the learning system according to the invention, a solution is therefore provided which realizes improved possibilities of context-oriented language training. The solution is based on the realization that for efficient language training, vocabulary should be learned in its context and this across different media, such as books that should be available in various digital formats, e.g. ePub, PDF, etc. Furthermore, the present invention is based on the realization that context-sensitive language training by means of these various media then gains efficiency, if annotated words or annotated word units, respectively, are offered in an exact page manner in synchronism to the flow of reading across these various media or across the different formats and/or even editions of these media, so that regardless of the medium, e.g. whether a text, an audio file or a video file is given, whether the text is physically read, a book and/or text, audio, or video files are offered across various digital platforms and formats, the user can respectively by means of filter adjust the annotation or the vocabulary to his individual needs. With this prioritization of needs, the present invention utilizes the realization that the users prioritization of learning is determined mainly by the factor of relevance, which is determined in an embodiment of the invention at least by importance and level of knowledge from the perspective of the learner by means of a respective individual relevance categorization. In other preferred embodiments, the vector determining the relevance for the prioritization can involve other factors, in particular, the linguistic level of the learner, the learner's learning focus in terms of topic or content, the learner's interest in certain subject areas and areas of expertise, the learning progress of the learners as well as third-party information in terms of e.g. a relevance based on community feedback.

The starting point of the annotated words or word units in exact page synchronism offered regardless of the media and/or formats is a reference medium or a reference page of the respective original text provided via the learning system 100, which is transposed preferably by means of comparison lists or matching tables to the different media, formats and/or editions. For this, the application service 110 comprises uniform APIs 140-160 and lower-level flexible functionality structures 112-116.

On this basis, the learning system 100 according to the invention provides different application modules which are illustrated in a schematic diagram in FIG. 2.

FIG. 2 shows that different modules can be provided via the application service 210, in the embodiment of FIG. 2, the author module 240, the reading module 250, the categorization module 255, the learning module 260, and the community module 270. Similar as shown in FIG. 1, firstly the application service 210 is via a data line 290 connected to the database 230 and also via corresponding data connections 290, such as an Internet 290, cable or wireless WANN or LAN or other preset-line or wireless network connections to the terminals 244-254.

The number and configuration of the application modules 240-270 of the application service 210 are of exemplary nature and may vary in different embodiments of the learning system 200. In particular, the application service 210 may in other embodiments comprise other or alternative and also additional application modules. Similarly, the number and type of terminals 244 to 254 is of exemplary nature, so that in other embodiments of the present invention, both different as well as alternative and further or additional terminals can be used. FIG. 2 shows terminals by way of example, such as a mobile computer or a laptop 244, a stationary PC 252, and an intelligent mobile terminal or Smartphone, respectively, and a multimedia device 254.

The categorization module 255 in a preferred embodiment provides functionalities and interfaces for user-specific relevance categorization within the meaning of personalized relevance. This user-specific relevance categorizations for individual words is stored as personalized relevance within the meaning of meta data for personalized word data records in the database 230. In the learning system 200 according to the invention, this individual categorization of subjective relevance can be performed both during reading (via the reading module 250) as well as during learning (via the learning module 260). Furthermore, relevance-categorization can be performed e.g. initially in the creation of the annotations by an annotation author (via the author module 240). Additionally, relevance-categorizations for words can also be created on the basis of community input. This can be done for example in that several community comments within the meaning of evaluation of relevance for relevance categorization are collected (via community module 270). Therefore, the categorization module 255 is in a preferred embodiment implemented as a cross-section module so that each of the other modules can access this categorization module 255 and use its functionality.

Determining relevance in the categorization module 255 is based on a vector being determined by various parameters. In a preferred embodiment, individual or subjective “importance” and an individual “level of knowledge” are considered as parameters for the respective word. In addition, in other embodiments, however, additional or alternative parameters, such as “time of reading” or the like can be used. Evaluation and weighting rules determine the subjective relevance category on the basis of these parameters. In one embodiment of the present invention, determination or calculation of the individual relevance or relevance category, respectively, is first set by default rules applying to all users, for example, the same weighting of “level of knowledge” and “importance”. Based thereupon, the categorization module 255 in one embodiment, however, also enables establishing personalized rules that govern determination of the individual relevance category or the subjective relevance prioritization, respectively. For this, inter alia the weighting of the parameters is changed or adjusted individually.

Thereby, the categorization module 255 is in one embodiment of the present invention for all words initially a predetermined “default relevance” being the same for all users based on evaluation rules for the parameters of the relevance vector, which are also the same for all users. This default relevance category can e.g. be set by a proposal from the annotation author and/or be based on community input. During the initial individual relevance prioritization by a user e.g. in the learning module 260 or the reading module 250, however, each user can perform individual relevance categorization for every word, which includes both individually changing or adjusting the parameters determining relevance as well as changing the evaluation rules determining relevance.

The categorization module 255 according to the invention further enables individual relevance categorization of non-annotated text, e.g. starting out from any PDF document, a website in a browser, or a physical print page. For this purpose, specific functionalities for identifying and importing a word and its context are provided. This can for example be done by manual copy and paste operations in the event of a digital source medium (website, PDF), by semi-automated parsing (e.g. as a browser plug-in) or even by using scanners and/or camera functionalities, e.g. of a Smartphone and subsequent OCR recognition (e.g. in the event of print originals). Subsequent to the identification and import of a word and its context, a proposal for translations is provided. This new word data record can then by using the categorization module 255 be individually relevance-categorized and thereby supplied for subsequent annotation and learning processes. This and the above-mentioned functionalities are provided both for text as well as for audio and video media. For this, subtitles for video and/or text for audio source material are for instance used in one embodiment of the present invention. Thereby, the same learning process can take place using various forms of media and terminals, e.g. with a mixed use of print and/or digital sources by application of Smartphone and camera functionalities, and/or by using OCR-functionalities.

The author module 240 according to the invention in a preferred embodiment provides functionalities and interfaces for creating context-oriented annotations. For this, the author module 240 generates a specific data record for each annotated word or phrase, respectively, that in addition to the word itself each contains a translation in a specific language and other meta data. The meta data of this data record in a preferred embodiment contains information on the linguistic level, the importance of the word, the language of the word in the original text and the translation, the category of words in terms of subject matter and technical areas, and information on the location of the words in the reference source.

Furthermore, the author module 240 according to the invention provides matching tables used for transposing the reference localization to other editions or variants, respectively, or even to other media and platforms of the original source. Thereby, the author module 240 via the matching tables according to the invention enables dynamic annotation of words or phrases depending on the source variant within the meaning of the version of the source, the format of the source, and the display platform on which this source is shown. Therefore, the author module 240 according to the invention in a preferred embodiment stores the respective word or phrase data record according to a multi-level data model as annotation master data for referencing this data according to a user-specific categorization in the database 230 of the learning system 200.

The reading module 250 provides the user with functionalities and interfaces for reading a source in exact page synchronism while simultaneously offering annotated words or phrases, respectively. In addition to offering annotated word or phrases in exact page synchronism, the user is enabled to categorize the offered annotation words or phrases via the functionalities and interfaces of the reading module 250. This categorization is according to the invention based on the subjective assessment of the offered words or phrases by the user, where different parameters can by set by the user for the categorization such that a relevance value is calculated from the parameters as a vector. In a preferred embodiment of the present invention, the relevance vector is calculated on the basis of at least two parameters, namely the subjectively assessed importance of the words for the respective user and the respective level of knowledge of the user regarding this word at issue. In a further embodiment of the present invention, the relevance vector can include alternative or further, i.e. additional factors in the calculation of the relevance value such as the linguistic level of the learner, the learning focus of the learner, the specific interest of the learner, the current learning progress as well as information from third parties arising from a community relevance vector.

For offering annotated words or word units in exact page synchronism, the reading module 250 according to the invention provides functionalities for dynamic transposition of stored annotation master data. These functionalities transpose the data stored in the database 230 dynamically to the read flow of the user to the annotated words and phrases on the basis of the source variant or the source version used by the user and the display platform for the source respectively selected by the user. By means of these functionalities of dynamic transposition, the words annotated for the respective source are referenced in exact page synchronism and provided to the user such that exactly the correct annotated words or phrases are displayed for the page of the medium which he or she is presently reading.

Furthermore, the reading module 250 according to the invention provides dynamic filters enabling the user to store the respective referenced or displayed words according to his respective preferences. These filters rely on the meta data of the word data record and thereby enable the user to individually and at any given time determine which words or phrases are to be displayed in exact page synchronism for reading. Therefore, the user in a preferred embodiment sets filter criteria inter alia including information on his linguistic level, information on specific learning focus, information on the technical content of interest, information on the current learning progress and also information to what extent third-party relevance criteria such as community relevance are to be considered in the selection. Furthermore, the reading module according to the invention provides read-parallel and user-specific categorization options for the user by means of functionalities and interfaces.

In a preferred embodiment, a number of words are referenced or displayed, respectively, which correspond to the user-specific filter setting. For each of these words, the user of the learning system 200 according to the invention can in parallel to reading change the categorization, in that he in a user-specific manner sets or changes, respectively, the respective criteria of the respective words within the meaning of meta data of a personalized word data record. In this sense, the user is for each displayed word shown a dialog by the reading module 250 according to the invention in which the parameter values of the meta data set at the respective time in the word data record are displayed. This meta data being used to calculate the relevance vector can in this dialog be specifically be changed by the user such that depending on the user input, individual words are awarded high importance, others less important, still others are awarded a high level of difficulty and still others are assessed with a good level of knowledge. On this basis, the reading module 250 according to the invention generates a personalized word data record specific to the user and the point in time, which upon a further read or selection operation of the respective user is used to re-calculate the relevance of a word and consider this for the selection of the word. The personalized word data record is in turn stored by the reading module 250 according to the invention in the database 230 of the learning system 200. For each user, the learning system 200 successively generates a set of words individually categorized or prioritized or provided with an individual relevance that can be used for efficient context-oriented language training.

This context-oriented language training is further supported by the learning module 260 according to the invention, which provides the user functionalities and interfaces for user-specific vocabulary training. The learning module 260 according to the invention uses the quantity of user-specific categorized or prioritized word data records that were generated from various sources, media, formats, etc. and stored in the database 230 in relation to the respective user.

By means of the application of filters and the use of scenarios, the user is enabled by the learning module 260 to have displayed exactly the vocabulary to be learned. Furthermore, the learner is displayed the respective word in its respective context, meaning in connection with the text surrounding that word or word unit. In addition, the user is in a preferred embodiment further displayed information on the searched word, e.g. the title used, the author and the like. Based on the information displayed, the user is offered a context-oriented form of learning having increased efficiency. Furthermore, the learning module 260 by means of accessing the categorization module 255 provides the user with user-specific relevance categorization of every word during or after each learning process.

In one case of application, learning words is performed in synchronism to reading a medium, so that in particular the words and expressions of an annotated medium being of individual interest to the reader can be categorized using the categorization module 255 and then be learned in a timely manner using the learning module 260. Thereby, the user does not during reading need to categorize relevance of all words displayed or annotated, but only highlight the most interesting words by means of the subjective categorization. This greatly increases efficiency of the learning process.

Alternatively or additionally, annotated words and word units can ideally before or after or even during reading of annotated texts be learned in a timely manner and ideally using appropriate filter selections (e.g. based on the page number of the source medium, the relevant linguistic level, relevance category, etc.) using the learning module 260 and words possible learned for the first time can using the categorization module 255 be prioritized by the user such that the relevance default value preset by the system 200 is replaced by a subjective or individual relevance category value. This new or personalized relevance categorization is then effective during the next or following learning session. For every learning process, the various parameters and/or evaluation rules can be individually and newly determined by the user using the categorization module 255 according to the invention

Use of the categorization module 255 can therefore be both in synchronism to reading as well as in asynchronism, for example, when learning a text in a timely manner and several times. Based thereupon, the learning module 260 in combined use with the categorizing module 255 also in certain display areas enables the mere display of the words to be learned without any previous text-synchronous learning process and/or previous determination of individual relevance categorization of words and word expressions prior to or during or after reading. For example, this can in one embodiment of the system 200 be done in that at the beginning of a chapter and/or at the end of a chapter, a list of relevant words to be learned is displayed as a summary. This form of learning is enabled by the learning module 260 according to the invention on various terminals 244-254 using various media. This further increases the intended learning effect by means of the option of timely repeated learning, e.g. in that all relevant words of a section just being read are again in summarization displayed for repeated study. In various embodiments of the learning module 260, this repeated compilation of words can be done with or without displaying the context surrounding the respective word. Furthermore, in embodiments of the learning module 260, the amount and type of repeatedly displayed words can be individualized using filters and setting options.

For the realization of context-oriented language training, user-specific relevance-categorized words are embedded in the source context of the respective source within the learning system 250 according to the invention, so that the user in the learning process can perceive and learn the specific word not only as a single word, but also in the context of the respective source of origin.

In a preferred embodiment, this context-orientation is realized not only for words originating from annotated sources, but the user, as explained above, is also enabled to include words in the user-specific relevance-categorized vocabulary replacement [sic] that originate from non-annotated sources. To avoid redundancy and to increase performance of the learning module 260 according to the invention within the learning system 200, storage of the user-specific relevance-categorized words is based on a multi-level data model or multi-level data storage, respectively, so that portability of the word data records to a variety of media platforms, such as third-party platforms 162 to 166 is ensured.

Next, the learning system 200 according to the invention provides the community module 270, which, for example, by connecting the application services 210 to third-party platforms 162 to 166 enables extension of the use of the aforementioned author modules 240, reading modules 250 and learning modules 260. By providing the functionalities of the author module 240, authorship is in a preferred embodiment of the present invention extended via the community-module 270 to third-party platforms 162 to 166. For this, the community module 270 provides annotation master data on these third-party platforms 162 to 166, for example, the community “Facebook”. This annotation master data is generated by referencing the word data records of the database 230. Therefore, by means of the community module 270, not only annotation master data of the original source context can be provided, but also words that are user-specifically categorized or taken from non-annotated sources on the third-party platforms 162 to 166 for the creation or revision of the annotation or translation, respectively. Therefore, the community module 270 according to the invention provides functionalities and interfaces that allow the users of the third-party platforms 162 to 166 to revise existing annotations and/or translations, so that a new version is created for the respective annotation or translation, respectively. Furthermore, the community module 270 according to the invention provides functionalities and interfaces to transform existing annotations and/or translations to another language. For example, via of the community module 270, new language pairs can be created and transformed in the annotation master data. Furthermore, the community module 270 according to the invention in a preferred embodiment provides functionalities for compiling the feedback of multiple users with respect to the categorization of annotation master data so that a “network relevance” is calculated. For this, the categorization of multiple individual users of the community module 270, i.e. the respectively entered parameter values of the word meta data is merged via a functionality algorithm to one common community relevance vector.

To ensure the implementation of the above-mentioned author modules 240, reading modules 250, learning modules 260 and community modules 270, the modules of the application services 210 are preferably implemented in multiple languages so can that various character sets are controlled and displayed by these modules, respectively. This is done in particular in a preferred embodiment such that a variety of character sets can be displayed simultaneously, for example, European, and Cyrillic character sets, or European and Asian character sets, or even simultaneously Cyrillic and Asian character sets. Furthermore, the implementation of the uniform Application Programming Interfaces 140 to 160 described further above is such that availability across different platforms is ensured for the modules of the application services 210.

Reading or categorizing words in reading synchronism via a Web browser is thus in a preferred embodiment enabled via the application service 210. In a similar way, however, the platform of an eBook reader by the users of the modules 240 to 270 of the application services 210 is possible. Furthermore, the modules of the application services 210 according to the invention are also accessible via mobile terminals such as mobile phones, multimedia devices, and/or mobile computers such that reading and learning in reading synchronism is enabled by means of the combination of either digital media and digital annotation data and/or reading a physical book while having a annotations reader 250 running along in parallel.

For this, a complex multi-level data structure is stored via the application service 210 in the database 230 according to the invention that enables working with the application modules 240-270 according to differentiated methods. In particular, the application service 210 according to the invention enables the display of any language pairs, in particular combinations, such as source language Arabic and annotation language Chinese. For this, functionalities for cross-media representation of different character sets are provided, in particular of different pairs of character sets.

FIG. 3 by way of example shows extracts from the interfaces and functionalities of the author module 240 according to the invention in the user interface 300. The author module 240 of the invention preferably provides functionalities via the user interface 300 that are accessible by means of tabs 302 to 314 Tab 302 enables the user of the author module 240 to enter basic data such as the author, the project name, the title of the source to which the project relates and uploading the content or the content of the source 350, respectively. In a preferred embodiment, an annotation project is versioned by means of the creation date. Furthermore, the author of the original and the language of the original and the annotation language are recorded for each project. In addition, meta data of the original source is in a preferred embodiment recorded, such as content category, topic area, and medium of the source.

By using various project-specific functionalities of the tab 304, the author of the project can in a preferred embodiment assign roles in the project in order to determine who in this annotation project is authorized to perform which activities (write, read, modify, store, share, . . . ).

Furthermore, details of the publication can in a preferred embodiment here be maintained in the book shop as well as information on the project status. Furthermore, the functionalities of the project tab 304 preferably enable publication of messages for searching for team members and/or translation aids. The layout tab 306 in a preferred embodiment provides functionalities that enable the project manager of the project to influence the basic layout of the text 350 of the original source. Furthermore, multimedia data can preferably be assigned to the source by means of the multimedia tab 312, for example, audio books in various pronunciations, videos and/or illustrations.

The sequence, number and content of the tabs 302 to 314 are more of exemplary nature and may vary in different embodiments of the learning system 200. In particular, additional or also alternative tabs can be displayed in the menu bar of the author module 240 according to the invention. In a preferred embodiment, functionality content and sequence of tabs 302 to 314 are designed from the left to the right such that the sequence or the functionalities, respectively, of the tabs 302 to 314 correspond to a process flow which is basically from the left to the right in processing the project. Preferably, however, the author module 240 is designed such that no stringent process flow must be adhered to, on the contrary, frequent iterations are favored.

In a preferred embodiment, the author module 240 is adapted such that the interface of the author module 240 is displayed by a web browser. Preferably, selection of the tab 308 enables changing the author in the marking mode of the author module 240. In the marking mode 308 of this preferred embodiment, it is possible for the author to mark relevant words and word units using mouse gestures. The author performs categorization based on the marking. This categorization is in a preferred embodiment done by indicating the word class (e.g., adverb) and the style level. Within this meaning, the categories “basic”, “advanced”, “challenging” and/or “word unit” are offered for each marked word, preferably as language categories. Furthermore, the author is preferably offered to associate the words with a knowledge area or a knowledge container, respectively, so that he can also categorize the technical association of the word or word unit, respectively. By way of example, the author can associate a marked word unit or a marked word with the knowledge area “geographic”, “historic”, “cultural”, and/or with the category “technical term”.

Thereby, the author is enabled, preferably by mouse marking and/or double clicking a mouse or another input source, to mark one or more words in the displayed context 350 to this word or these word units and subsequently by means of an additionally displayed legend 330 select the appropriate word or knowledge categories 335, respectively. Preferably, storing this categorization selection is effected automatically in the database 230 of the learning system 200 as a word data record such that the category information 335 from the author is stored as meta data of the word record. This annotation meta data inputted by the user of the author module 240 can be used by the user of the reading module 250 and the learning module 60, respectively, to control the display of the words to be learned or the display of the annotated words, respectively, by appropriate filter information such that only those words are displayed which correspond to the respective interest or the current prioritization of the user, respectively.

The annotation is performed by the user of the author module 240 according to the invention preferably in exact context on the respective page of the original source 350. This promotes a good and fast flow of reading of the learner by means of reference to the exact meaning of a word in the respective context and the lesser amount of explanations necessary for the word due to context-embedding. The author module 240 according to the invention preferably provides additional features for the author, so that in addition to the category of word, the category of knowledge and the translation of the word, other meanings, e.g. alternative meanings, information on transcription, multimedia files for aiding pronunciation and the like can be stored. Thereby, the user of the author module 240 creates a study unit for each word which is stored in the database 230 according to the invention and each displayed to the learner in the context such that according to new findings in neurobiology, a strong bondage can be created by perceiving the respective word in context.

In one embodiment of the present invention, annotation and categorization of the annotated words is done manually by the user of the author module 240. In a further or additional embodiment, this annotation being performed by a human author can be supplemented on the basis of the individual or personalized vocabulary of a learner. This personalized vocabulary or this learning base in one embodiment of the application services 210 enables performing standardized categorizations for additional, in particular, new words based on the words and their meta data existing in the learning base, and to create automated and personalized annotations for new texts, in particular, additional and previously not annotated texts, without this requiring manual intervention on the part of a user of the author module 240. This can be done for example by omitting words that have been categorized by the user as being “known” in the framework of the learning progress in his learning base, or in that in new, previously not annotated texts, such terms being designated by the learner in other sources as being “important” are automatically highlighted, annotated with at least one translation, for example, taken from third-party platforms sources 162 to 166, and offered for subjective categorization.

In a preferred embodiment of the marking editor 308 according to the invention, the markings by the user of the author module can be highlighted in the text of the source, for example, highlighted in color by respective color-coded marking of the annotated word or annotated phrase and additionally or alternatively, this highlighting is done by colored pipe bars in the course of the text. Preferably, the marking editor 208 enables nesting markings such that e.g. a proverb can be marked categorized as a word unit and simultaneously within the proverb, a single word can additionally be marked and annotated.

The annotation editor 310 of a preferred embodiment of the author module 240 is started by selecting the respective tab 310. Preferably the annotation editor displays the context or source text 350, respectively, on one side and the annotated words 315 in exact page synchronism on the other side of a screen representation. Selection of the marked words can alternatively also be alphabetically so that overview information is displayed for each word, for example, within the meaning of a table, so that the author can recognize, for example, what information has already be given e.g. in terms of categorization and in terms of additional information for the respective annotation words. In a preferred embodiment, each word data record comprises at least specifying a basic form, specifying additional information, specifying a word class, specifying a style level, as well as the context significance or short description in the language of translation other additional meanings or long descriptions, author comments and additional specifications, such as links, or also additional general translations. The preferred embodiment of the author system 240 according to the invention comprises at least the basic form of the annotated word and its context-specific translation within the meaning of a short description as default fields of a word data record.

Preferably, categorizations such as word class and/or the style level are preferably not entered as free text information, but as a selection from a limited list of values for this category. In addition, the annotation editor in a preferred embodiment comprises several tabs for entering word data records in different translation or annotation languages for a respectively annotated word. Preferably, the annotation editor 310 additionally comprises functionalities with which the author can create posts in forums platforms 162-166, so that also other users of the system can indicate possible translations. Furthermore, preferably workflow management functionalities are provided such that individual participants of an annotation project can communicate with one another. For this, preferably a share procedure is furthermore provided, so that input, change and share rights can be clearly defined and executed By specifying the knowledge categories, additional meanings and long descriptions, the learning system 200 according to the invention not only enables the annotation of words within the meaning of individual words and word units, but also enables annotation of cultural, technical and language-specific knowledge, which can thus be learned by the user of the learning system in a context-oriented manner in exact page synchronism.

The author module 240 according to the invention thereby enables context-oriented annotation of words and/or phrases by the user of the author module. In a preferred embodiment, a text being converted into a plain text format is loaded into the author module 240 or retrieved by it as a basis for an annotation. The starting point for this conversion process can be different digital formats, such as text formats of common word processing programs or formats of layout or graphics application programs, such as the known PDF-format. Similarly, however, conversions can be performed on the basis of multimedia output sources such as audio and video files. In this case, preferably text-to-speech technology is applied for the conversion.

On the basis of the conversion starting out from the original source, the text is imported into the author mode of the learning system 200 or its author module, respectively. Preferably, this can be done by means of the functionality of the marking editor 308 or also the project tab 302. In one embodiment of the learning system according to the invention, such an upload is performed in txt-format. After this upload of the content, the author can in the author module 240 according to the invention change over to the marking editor 308. Here, as described above, the author can highlight and thereby annotate the words that he found to be of importance. Preferably, the marking editor implements the highlighting of relevant text passages while maintaining the existing text of the original source. In one embodiment of the present invention, the marking editor is implemented as a functionality within the display of a website via a web browser. To avoid interfering with the author's flow of reading, a concept of asynchronous data transmission is used in a preferred embodiment, which, starting out from the author's input, enables communication with the database 230 and correspondingly updating the displayed page, without there being the need to completely newly reload this page. In this preferred embodiment of the browser-based marking editor 308, a desktop-like behavior is in this manner simulated in the web browser, e.g. in the form of pop-up windows. The marking editor 308 in the embodiment as a web application thereby during the author's entries communicates with the database 230 so that markings by the author are transferred automatically and without delay to the database 230 as annotation master data. In addition to the marked word or marked word units, categorization information from the author is stored as meta data with the annotated word master data record. This meta data in a preferred embodiment describes information about the linguistic level of the marked word or phrase and on the subject and technical field of knowledge in which this word is embedded. In one embodiment, the linguistic level is categorized in the stages “essential”, “advanced”, “challenging”, and independently of these three stages it can be specified whether this is a single word or a word unit i.e. an expression. Furthermore, in one embodiment of the learning system 200, the subject and technical field of knowledge of the annotated word is characterized along such specifications as “geographical”, “historical”, and/or “culture”. Regardless thereof, the author can mark whether in the case of the marked word or word unit, this is a “technical term”.

If text or a word or word unit is marked, then an asynchronous data transmission request is in one embodiment of the present invention transmitted to the application server 210 or the database 230, respectively. This request contains an identification number which is associated to the marking or the tag, the marked word or word unit, as well as the aforementioned information on the marking categories or meta data, respectively. This database request creates a data record in the table of annotation master data and links this data record with the author project or ID of the author project, the annotation or the tag itself as a string and the respective parameterized category values. After execution of this asynchronous database request, the respective text passage or the respective word is in the editor view 310 in one embodiment of the author module according to the invention extracted from the text and highlighted. When using web technology for the implementation of the marking 308 or annotation editor 310 according to the invention, for example, HTML and Cascading Style Sheets can be used for this. FIG. 3 shows an embodiment of this marking editor 308 according to the invention, in which the word “Lurem” is marked and highlighted accordingly.

Localization of the respective annotation or the respective tag is preferably performed by the author in the annotation editor 310. In the annotation editor 310 the author has the option to create a dedicated translation for the languages he desires. For each annotation or word data record in the annotation master data of the database 230, preferably several specifications can be made for each language desired. In one embodiment of the learning system 200 according to the invention, users of the author module 240 specify for each language the information and basic form, additional information, word class (noun, verb, adverb, etc.), style level, (colloquial language, higher level etc.) contextual meaning and short description, additional meaning or long description, reader comment and a link to additional information or media. In one embodiment, the basic form and the contextual meaning are provided as default fields. However, in other embodiments, other or additional or alternative information can be provided as default or optional value of a word basic data record.

By means of the ID of the annotation data record, a link to additional information of the short description or the long description is established, as they may vary in one embodiment of the present invention. After providing this information, the author stores the data record in the annotation editor 310. When a project is completed, the author therefore has totally annotated a book or a source, then in one embodiment of the present invention he can export this work to the shop part of the reading module 250 of the application service 210. This export is preferably treated as a publication. Therefore the content of the book is during exportation in this embodiment transmitted as published annotation master data and re-stored. During this transmission, it is preferably checked whether the project has already been published, so that in the event that there is already a publication of this source, the new publication receives a different, i.e a new version number. Thereby, the author is given the opportunity to adjust his annotation at any time and the user of the learning system has the option of continued access to the older version and to read it and to learn based thereupon.

In other preferred embodiments, the marking 308 and annotation editor 310 can employ speech technologies that perform automated markings and create context-based annotations. In the case of video or audio source material, speech-to-text technology is used to produce source text on the basis of this original material. Involving third-party platform 162 to 166 further enables extension of access to the author module 240, so that the possibilities of Crowded Sourcing can be used. By means of the number of authors but also by individual authors, specific expert knowledge can be recorded, explained and made learnable, so that also historical terms, specialist terminology and the like are available for the user of the learning system 200 by means of the annotations.

FIG. 4 by way of example shows an annotated text as it is retrievable after completion of an annotation project in the author module according to the invention via the application service 210 of the learning system 200 according to the invention. An embodiment of the output of annotated sources is shown in this example, in particular an extract in PDF-format, which on the left side comprises the annotated text and on the right side has the context-related translation in the annotation language. In this embodiment, the annotations in the text are highlighted by underlining and further marked by numbering. Thereby, it is in this embodiment facilitated for the user to identify the respective word on the right side in the annotation, and thereby without interrupting the flow of reading, to read, learn and associate the respective context-related translation of the annotated word. This particular example shows the implementation of the aforementioned ability of the learning system 210 of being able to process different character sets simultaneously, in this particular example, the combination of a standard ASCII character set with a Cyrillic character set due to the translation or annotation, respectively, from English to Russian. Similarly, annotated sources can also be acquired and read in the reading module 250 according to the invention of the learning system 200 according to the invention. The example of FIG. 4 therefore shows an embodiment of the already above-described reference medium, in this example, an annotated PDF-document as a reference document.

In order to read such a source that has been annotated, the user of the learning system 200 first purchases one or more titles. For this, a shop functionality is provided in one embodiment of the reading module 250, which enables the user of the learning system 200 to purchase one or more titles. The available titles are preferably displayed with their title, the source language and the language of explanation. Furthermore, meta data for the annotated source is preferably displayed, such as the number of annotated words, the number of annotated words in specific categories, such as the number of words in certain word classes, in certain areas of knowledge, in certain linguistic levels, etc. Furthermore, the user decides in this shop functionality in which format he wants to purchase this source. In one embodiment of the reading module 250, the user is therefore offered a PDF-download but there is also the parallel option to load an ePub file. Other alternative and/or additional formats of the digital nature can be offered in other embodiments. In addition to downloading the entire file, i.e. the source text and the annotations, there is also the option to download only the word list of annotations in order to use it in parallel to reading a physical source, i.e. a physical book. Besides downloading, it is also offered preferably in the reading module 250, to read the annotated text online, i.e. in the browser on a computer, laptop or mobile phone, in a comparatively similar form to the representation of FIG. 4.

In further embodiments, the user based on the acquisition of a source is offered various functionalities, such as specific forms of interactive reading and learning, forms of games that can increase motivation to learn and specific eLearning forms. Download options, platform compatibilities, versions and learning options are offered for all the titles of various formats, which are in one embodiment of the present invention designed as a digital user-specific “bookshelf”. In addition to the different formats, versions and forms of downloading an entire source, also audio files and word lists to the respective print sources can additionally be made available. Therefore, the user of the reading module according to the invention is in addition to the annotated sources also offered to purchase audio books with several different pronunciation variants for each title and/or audio books with several pronunciation variants for each word, and accordingly, also videos. In addition, various games and forms of learning exercises are offered enabling alternative forms of context-based learning specific customization.

Thereby, the reading module 250 according to the invention already at the time of purchase provides customizing functionalities, which may preferably extend to the output format of the source purchased, the layout of the source, e.g. in terms of the format, the font, the design in black and white or in color, the highlighting of words on different linguistic levels and the filtering of displayed words according to categories, the explanation of technical terms, etc., the selection of the output format or platform, respectively, such as ePub and PDF.

With the purchase or the placement of an order in the application service 200, various operations are performed, which support the user in getting into reading and learning directly upon successful ordering. In one embodiment of the present invention, a special order data record is stored in the database 230, which stores the data describing the order process. Part of this data in a preferred embodiment is the identity of the user, the specific combination of the publication and annotation languages of a project selected by the user as well as its version. Therefore, the user can chronologically access successive versions of a project. Each of these publication versions can there contain several annotation languages which can be purchased individually or in aggregate by the user. Furthermore, the linguistic level of the order is stored as a linguistic Level in the order data record, and the user of the order process can limit the number of annotations or tags to the desired linguistic level.

Furthermore, all orders of a user session are in a preferred embodiment summarized such that the user at the check out from this session acquires the rights to all the individual orders summarized in this data record. Thereby, after a successfully completed ordering process, all purchased media are part of the digital bookshelf of the user, which is stored as a personalized media set for the respective user in the database 230. The user can therefore starting from there begin exporting these media, by which in addition to the respective media file, e.g. a PDF-file containing the media text and annotated links, further user-specific data can be written to the database 230. For ensuring page-based learning or display of the annotations in exact page synchronism, the position of the markings or tags, relative to the page and/or chapter are in a preferred embodiment during exportation stored in an annotation data record. These positionings of the markings or annotations, respectively, preferably depend on the restriction set by the user during the order procedure regarding e.g. the linguistic level and/or other categorizations regarding the meta data of the word data records. Position storage is therefore based on the restriction of the entire marking volume in the published project which the user has purchased.

Therefore, the described data for the annotation words is stored in the user-specific annotation data record. This preferably includes the string literal of the marking or the text, respectively, its grammatical specifications and associated meta data, e.g. describing the linguistic and stylistic characteristics of the marking. Thereby, in the multi-level data storage model of the learning system 200 according to the invention, the marking or the tag, respectively, is treated as a central data unit for e-Learning and linked to the related project via a common connection to the version level of the publisher. This data being captured or calculated during the order process and the subsequent exportation of the ordered media form the basis of the learning functionality of the learning module 260 customized to the personal needs of the respective user.

FIG. 5 by way of example shows an embodiment of the user interface of the reading module 250 according to the invention. Similar to the illustration in the downloaded PDF-format, as was shown e.g. by way of example in FIG. 4, here as well, representation of the text occurs on the left side and the corresponding annotation on the right side. In the example of FIG. 5 the linking of different character sets is shown again, in this case a European character set linked with Chinese character sets. In one embodiment of the reading module 250, next to the text and its annotations, more multimedia files are displayed to the user, such as audio files e.g. which were e.g. integrated into the project via community functionalities of the third-party platforms 162-166. These audio files can e.g. include various pronunciations of certain words. In addition, the user is via links provided with further information, which were entered by the publisher of the project into the author module 240. Thereby, the user can in parallel to reading the text access audio files providing examples for pronunciations and thereby train not only reading ability, but also speaking abilities of the user.

Furthermore, the user is by means of the window 530 provided with the option to categorize words while reading, in order to define a personalized focus on relevant words. In the example of FIG. 5, the relevance regarding the importance (very important, quite important, not important) and the level of knowledge of the user (well known, hardly known, unknown) is determined. In a preferred embodiment, also other information is displayed in the window 530, such as pronunciation, the phonetic spelling, the basic meaning and the basic form as well as the contextual meaning of the annotated word. Links to the third-party platform 162-166 is by way of example shown in the functionality 560, which in the embodiment of FIG. 5 enables the user to connect to the IP communications platform SKYPE. In this manner, pronunciation can here be practiced by means of an oral chat. Before or after reading, respectively, the user is via the functionality 570 given the option to determine the number of annotated words, in which he in one embodiment of the reading module 250 firstly sets the relevance, determines the absolute number of annotated words (in this case 25) and defines the language direction of learning, in this case, from the source text to the annotation translation.

The learning module 250 therefore provides the user with the option to read a text and simultaneously categorize the markings or tags, respectively, in this text. Connecting the third-party platform 162-166 in various embodiments of the present invention enables firstly a connecting to the community platform via which additional content can be made available, and also enables connecting to online dictionaries enabling the integration of additional information regarding annotated words of third party producers.

Page-oriented learning is realized in the reading module 250 according to the invention, irrespective of the medium used or the formatting used or the digital format of the purchased source, respectively. This page-oriented learning is in one embodiment geared towards a reference source which, for example, can be the PDF-file, which was shown as an example in FIG. 4 In this embodiment, the PDF-file of FIG. 4, being shown by way of example in FIG. 5, was selected as a reference for page-oriented learning in the web browser. The page breaks within the PDF-document are there selected as being relevant for the electronically published source form, e.g. in an ePub-file. For this, table cells not visible on the pages being provided with a preset width and height are in a preferred embodiment used in the PDF-document. Based on these table cells, a counter is initialized in the author module 240, which checks whether there is space still available on the respective page. If this is not the case, i.e. the end of page was reached, the a new page will be begun. The digital publication algorithm e.g. for the publication of an ePub-file uses this algorithm of the reference source for generating this file. In order to realize the different possibilities of visual page distinction in various digital output formats in dependency of the platform or formats used, such as ePub or a mobile phone, a new file is then created in the respective digital output format and written to the table of content of the digital output format if the corresponding algorithm of the reference file indicates a new page in the reference source During publication e.g. in the output format ePub and a reference file as a PDF, then a new HTML-file is generated in the ePub and written to the table of content of the ePub-file if the PDF-algorithm of the ePub-functionality reports a “new page”. Each new HTML-file in the ePub therefore represents a new page. This functionality supports browser-based output, as is indicated by way of example in FIG. 5.

In this browser-based output, the user can therefore navigate through a page tree which ensures reading and displaying annotations in page synchronism. This functionality is in the learning system 200 according to the invention used in various ways, for example in eLearning such that the markings or annotations, respectively, are written to the marking data record together with the respective page number.

Similarly, as in the author module 240, a technique for asynchronous database access is used also in the reading module 250 in the embodiment of browser-based reading, so that the reader's flow of reading is not disturbed and the information in the window 530 can be established without the user being irritated by a reload of the website. The starting point for the display, which is shown by way of example in FIG. 5, is the retrieval of the version level of the published version of the purchased media. This is in a preferred embodiment based on the generation of an ePub file, which contains information about the structure of the document by means of the mechanism described above. The text content, which in the output format as ePub e.g. comprises HTML coding, is then searched for markings or tags, respectively. Within this page description language, markings are provided with an ID number, a classification based on the categories that the author specified and applied to the vocabulary text. These annotations can therefore be evaluated automatically, so that the word text is parsed for the ID, i.e. the content of the text is filtered out, recognized as word text and used as such in order to be shown as a hover display by means of a respective script within the browser display of FIG. 5.

For identifying the data record of the corresponding word in the system 200, the ID of the tag is used as a starting point. In this preferred embodiment being shown by way of example in FIG. 5, the user moves over a marking in the text and receives the window 530 displayed to the right of the text as additional information superimposed to the remaining interface screen. By opening this hover display, an asynchronous database request is sent to the application service 210 or the database 230, respectively. This database request reads out the annotation data records and using the ID verifies the parsed word. Starting out from the identification of the parsed word in the target language, the order data records of the respective user are checked to determine whether the respective word has already been sorted with relevance parameters, i.e. whether e.g. category parameters for importance and level of knowledge were stored. This information inter alia forms the basis for subsequent relevance-based and context-oriented eLearning. On this basis, the user can classify words such that he does not have those displayed that he already knows, and those are not displayed that he has rated as being unimportant, but that in turn those are displayed, which he does not know, and those are displayed which he has determined as being important.

For further performance of the hover display, the normal form of the respective word is retrieved from the annotation data record and displayed and short and long descriptions or additional information regarding the word from the translation data records by means of allocation of the respective IDs. This data is in a preferred embodiment sent to the browser as XML and written into the hover display. By means of the normal form of the word, platforms and third-party providers 162-166 can be queried in a parameterized manner and the return values of these queries can be displayed e.g. by means of links to respective online dictionaries or search queries. Furthermore, the user is in the hover display provided with the option to further sort the word, i.e. to change the relevance value of the word by specifying parameters on importance and the level of knowledge for which in a preferred embodiment three sort options each are specified.

If new parametrization is performed by the user, then a new asynchronous database request is sent to the application service 210 or the database 230, respectively, and the corresponding data of the order data records of the user are updated and newly stored. Since the data and information for sorting the words was created already during generation of the page 510/520 displayed in FIG. 5, the database request only serves new sorting or parametrization, respectively, and display of the word already sorted. The functionality algorithm of the asynchronous database request can thereby be reduced to a few states, in a preferred embodiment to that state delivering information for the word, e.g. meaning the basic form, the long and short description and additional information and a second state relating to the relevance of the word, e.g. composed of the level of knowledge of the user and/or the importance. If relevance has already been sorted or parametrized by the user, then this parametrization is preselected in the display on the basis of the execution of the database requests.

Therefore, the user is given the option via the reading module 250 according to the invention to independently of the medium be offered annotated words and word units in exact page synchronism to the flow of reading, which can be prioritized to meet individual needs. In addition, the user can perceive the source heterogeneously, i.e. simultaneously learn by means of text and/or audio. Determination of the relevance can in one embodiment be done in dependency of the time of reading and the subjective assessment regarding importance and level of knowledge. However, the user can in other embodiments set additional or other filters, such as the linguistic level, word classes such as subject or verb, place a focus on expressions or phrases, or on slang-terms. A fundamental principle of the learning system 200 according to the invention is thereby realized, namely, that the user can respectively set what is subjectively important to him, or known or unknown due to his level of knowledge. In this context, when purchasing the titles, however, not only the linguistic level can be set and decided what is to be displayed within the meaning of essential, advanced, and/or challenging words, but also the format of the title or its output formatting, e.g. in terms of font size, lay-out, of the designated word units. Additionally, the purchased titles can be narrowed down by means of further filters, e.g. subjects or technical terms.

Thereby, the learning system 200 according to the invention enables reading any text e.g. via digital media in, for example, browsers or eBook readers. The learning system 200 according to the invention is therefore in a preferred embodiment of the invention used as an extension of a browser software which when digitally reading any random text from a website reads out terms from this website or the web page text on the basis of the personalized user setting, information regarding the word being read out is taken from the database 230 by means of the described asynchronous database requests, and thereby displayed as a superimposed display, for example, similar to the hover display 530 for digital text of the website, so that the user can individually categorize these respective expressions for later learning.

Cross-media and contextual learning of words is thereby enabled across multiple output media, for example PDF, EPUB, printed books in various editions and different platforms, such as Smartphones, computer, laptop, etc. Based on the media purchasable via the shop functionality of the reading module 250, synchronized learning occurs within in the meaning of offering annotations on the same page or in exact page synchronism, respectively. This takes into account the respective version or versioning, respectively, of the medium, i.e. new annotations or changed annotation, respectively, of individual titles during reading. Thereby, the user of the reading module 250 according to the invention has the option to within the reading mode change to new or other versions without losing the learning or categorization results of what he previously read or of the previously read version, respectively. During the first reading, the standard rules for the relevance-based prioritization of the displayed annotation words are used in a preferred embodiment. However, personalized rules are established due to customized categorization being offered during each reading process, so that there is at least subjective prioritization. This can be complemented and/or overlaid by user input, by objective prioritization e.g. from authors and/or community-prioritization in terms of e.g. relevance determination based on multiple feedback. In this, the publishing functionality of the reading module 250 enables publication of the media in parallel in different international character sets, as shown in FIG. 5 and by way of example in FIG. 4.

Based on the above-described order or the purchase of media, respectively, several of these media acquired by the user can in the learning module 260 according to the invention be combined into a learning scenario. This learning scenario being a functionality of the learning module 260 according to the invention is shown schematically in FIG. 6. In this functionality, the user can preferably create a learning scenario such that he can created vocabulary for learning across titles, i.e. across several books and media, respectively. Therefore, definition of individual learning scenarios is enabled by means of the functionality of the learning scenario via the learning module 260 according to the invention providing efficient word filters in order to achieve a personal learning goal in an efficient manner.

In one scenario, preferably several titles are combined to form a study unit. For this, the scenario functionality, in addition to the specification of a name for the scenario 610, also offers the functionality to add multiple titles from a selection of titles to this scenario. This functionality 620 becomes the basis of the title list of those titles that the specific user has ordered or purchased, respectively, in the reading module 250 according to the invention. In this, the user is shown meta information on the respective titles that are part of the scenario. The scenario titles 630 are firstly displayed with the title, preferably further with information about the author, and information on the language pair in terms of the source language of the media and the translation language of the annotations. This will enable the user in a preferred embodiment to integrate titles of various directions of translation into one scenario. The example of FIG. 6 here shows a medium in a translation from English to German and another medium in the translation from English to Chinese. Furthermore, the user can set various filter criteria so that word lists are created from these media corresponding to the personal priorities of the respective user. For this purpose, information e.g. on the linguistic level, i.e. on the characteristics of the linguistic level to be considered, is provided in one embodiment shown in FIG. 6. Moreover, it is preferably displayed how many words the respective medium has annotated at the specific linguistic level On this basis, the user can respectively decide, how many words are included in a respective linguistic level. Furthermore, the user can decide how many of these words are in turn to be used for the vocabulary training. For this, he can in various embodiments set the absolute number of these words, or restrict the selection of words to certain pages of the source. Thereby, the user of the learning module 260 according to the invention can e.g. specifically set for which pages of the original source text he wants to prepare during this learning scenario.

Thereby, the user is in the learning module 260 according to the invention in one embodiment offered at least two different ways, how he can learn specific words on the basis of selected titles. The example of FIG. 7 shows that this vocabulary training can be based on either a single title from which the relevant words are selected, or on a scenario that includes a variety of media, and also here a user-definable number of words 710 is selected with a user-definable relevance 720 from the media of the respective scenario.

Furthermore, the user can in a preferred embodiment select the learning direction, i.e. from the source language to the language of explanation, or vice versa from the language of explanation to the source language. Thereby, the user is enabled to select the words and phrases or expressions that are individually of interest to him from the respective texts, read them and learn them in a memorable manner. By compiling title-spanning scenarios, a specific learning environment exact to the page is provided from a wide selection of titles. This accuracy is according to the invention achieved by the user determining relevance, where the user can determine individually during learning how important individual words are for the user and thereby achieve optimization of the learning success.

This end-to-end optimization with respect to the relevance of words is continued after the user has selected the functionality of the eLearning 740. After selecting the functionality 740, the first of the words being selected by the user by means of relevance and number appears. In the display of the word 750 schematically shown in FIG. 7, not only the word itself, but also the context 760 is displayed in which this word is embedded 755. The term “context”, in this as in the previously explained contexts, refers to the text or the audio or video segments “around” the word at issue and/or the searched phrase, respectively. This context can be by way of example be characterized by 100 characters respectively to the left (preceding the word in text) and to the right (following the word in the text). Alternatively, this can also be done by respective time units for audio and/or video segments as well as by alternative or different suitable characterizations.

Furthermore, the user is offered options for categorizing 770/780. In the example of FIG. 7, relevance-oriented categorization is based on the level of knowledge and the importance, each being rated individually by the user. Thereby, the user can via the level of knowledge 770 set whether these words are rather more known to him or less known, or whether the importance 780 has become grater or less. Additional information, such as information about the underlying titles 790 and connections to third-party platforms enable comfortable handling of the learning environment. Therefore, the relevance of each word for the individual user and the particular time from the feedback of the user, respectively the updated categorization, are taken over. Initially, uncommented words are given a default value.

In addition to the varied forms of vocabulary learning, forms of learning through playing can be offered. Examples of these embodiments of learning through playing in the learning system 200 according to the invention are shown in FIG. 8. During the game 810, the user will be prompted to find a word letter by letter in a context. For each failed attempt, another dash is added to the indicated gallows. An alternative game form is shown by the game 820. Here the searched word is displayed with its letters, but these are placed in chaotic sequence by a random generator. Here, the user is encouraged to complete the word or the phrase searched for by dragging individual game elements from the top line to the base line. For this purpose, a time allowance is provided, so that fast identification is practiced.

In addition to these game forms, the learning module 260 according to the invention further enables automated transmission of word lists, which can also be entered by means of relevance or categorization and selection of filters and/or parameter values, respectively. These word lists can in one embodiment, for example, be entered such that dispatch to the user is effected every day at a certain time e.g. by email or as a text message to a mobile phone or in an alternative form. This can be used to deepen the learning result and/or to prepare for or follow up on reading other texts. The use of these different forms of learning is enabled by the implementation of the learning system 200 in the application service 110 and the flexible APIs 140-160. Therefore, in other embodiments of the present invention further, i.e. additional or alternative forms of learning can also be implemented

1. A computer-implemented system for learning words and word units, wherein annotations for said words and word units are offered and displayed in exact page synchronism with the source medium and said annotations can be selected by the user when reading said source medium and can be synchronously relevance-categorized for timely learning, said system comprising:
an author module comprising software-implemented means adapted to load a source medium in a converted manner, to provide a marking editor (308) enabling annotation of words and word units in synchronism with the display of said converted source medium and further to provide an annotation editor enabling specification of multimedia word basic data and meta data for said annotations in parallel to the display of said converted source medium;
one or more databases which based on the entries in said marking and annotation editor for each annotation store an annotation master data record comprising said word basic data and meta data; and
a reading module comprising software-implemented means being adapted to select one or more media for the display, to display a preset number of annotations in exact page synchronism with said display of said medium when reading of one of said selected media, and further being adapted to provide functionalities for user-specific categorization for determining the relevance of said annotations, where said marked annotation is stored in a user-specific annotation data record in said database.

2. A computer-implemented system according to claim 1, where said annotations can at a certain time be categorized and selected by the user in terms of their relevance,
where said author module is further adapted to allocate a linguistic level and context parameters to said annotations,
where said one or more databases for each annotation based on said meta data determines and stores a relevance and which further for each source medium stores at least one matching table defining the allocation in exact page synchronism for each annotation with respect to a medium and relative to a reference medium, and
where said reading module is further adapted to enter, for each selected medium based on said user-specific annotation data record, a multidimensional relevance categorization for annotations to be displayed, and to provide functionalities for updating said user-specific relevance of an annotation based on user-specific parameters for one or more elements of said meta data, said annotation being stored with said updated relevance in said user-specific annotation data record.

3. A computer-implemented system according to claim 2, where said elements of said meta data being considered for the calculation of said relevance value at least comprise said level of knowledge of the user in relation to said annotation and said importance of said annotation from the perspective of the user.

4. A computer-implemented system according to claim 3, where said reading module for said selection of displayed annotations relies on said user-specific annotations master data records stored in said database, and said relevance-prioritization is applied to said user-specific relevance of an annotation.

5. A computer-implemented system according to claim 1, where said reading module is executed and displayed on a mobile terminal and provides functionalities for a user-specific relevance-categorization.

6. A computer-implemented system according to claim 1, where said text of said medium and said annotations displayed in parallel are displayed in a window of a digital display or a web browser.

7. A computer-implemented system according to claim 1, where a number of relevance-prioritized annotations are displayed as a list of annotations in exact page synchronism in an annotation reader.

8. A computer-implemented system according to claim 1, where said annotation reader is executed as an application on a mobile terminal.

9. A computer-implemented method for learning words and word units, wherein annotations for said words and word units are offered and displayed in exact page synchronism with said source medium and said annotations can be selected by the user when reading said source medium and can be synchronolously relevance-categorized for timely learning, said method comprising:
loading, converting and displaying a source medium;
annotating words and word units in synchronism with said display of said converted source medium;
specifying multimedia word basic data and meta data for said annotations in parallel to said display of said converted source medium;
based on said specified word basic data and meta data, storing an annotation master data record for each annotation comprising said word basic data and meta data;
selecting one or more media for display;
selecting and displaying a preset number of annotations in exact page synchronism parallel to said display of said medium while reading one of said selected media; and
categorization for determining said relevance of an annotation, said relevance-categorized annotation being stored in a user-specific annotation data record.

10. A computer-implemented method according to claim 9 adapted for operating a system for learning words and word units, wherein annotations for said words and word units are offered and displayed in exact page synchronism with the source medium and said annotations can be selected by the user when reading said source medium and can be synchronously relevance-categorized for timely learning.

11. A computer-implemented method according to claim 9, where said source medium is obtained by means of scanning a printed text and/or
wherein said scanned text is scanned by means of a mobile terminal and OCR of said scanned text is performed.

12. A computer-readable storage medium in which computer-readable instructions are stored, which when executed by a computer are adapted to implement said author module in said system according to claim 1.

13. A computer-readable storage medium in which computer-readable instructions are stored, which when executed by a computer are adapted to implement said reading module in said system according to claim 1.

14. A computer-readable storage medium in which computer-readable instructions are stored, which when executed by a computer are adapted to implement a computer-implemented method according to claim 9.

15. A computer-readable storage medium in which computer-readable instructions are stored, which when executed by a computer are adapted to implement a computer-implemented method according to claim 9.

16. A computer-implemented method according to claim 10, where said source medium is obtained by means of scanning a printed text and/or
wherein said scanned text is scanned by means of a mobile terminal and OCR of said scanned text is performed.

17. A computer-readable storage medium in which computer-readable instructions are stored, which when executed by a computer are adapted to implement a computer-implemented method according to claim 10.
